(19) United States
(12) Patent Application Publication
(10) Pub. No.: US 2022/0313011 A1
(43) Pub. Date: Oct. 6, 2022

(54) Temperature Control Apparatus and Fermented Tea Manufacturing Method

(71) Applicant: Shenzhen Chenbei Technology Co., Ltd., Shenzhen (CN)

(72) Inventor: ZhiHong WEI, Shenzhen (CN)

(21) Appl. No.: 17/642,193

(22) PCT Filed: Dec. 27, 2019
(86) PCT No.: PCT/CN2019/129056

§ 371 Date: Mar. 10, 2022

(30) Foreign Application Priority Data
Sep. 10, 2019 (CN) 201910854339.0

(51) Int. Cl. A47J 31/56; G05D 23/19; A47J 27/21

(52) U.S. Cl. CPC A47J 31/56; G05D 23/1951; A47J 27/21058; A23F 3/166

(57) ABSTRACT

This application provides a temperature control apparatus and a fermented tea manufacturing method. The temperature control apparatus includes: a base housing, a controller, a heating component, an air supply component, and a temperature sensing component, where the controller, the heating component, and the air supply component are disposed in an inner cavity of the base housing; the controller is electrically connected to the heating component; the controller is electrically connected to the air supply component; and the controller is electrically connected to the temperature sensing component; and the controller is configured to perform temperature control, and is specifically configured to: control, based on a temperature detected by the temperature sensing component, the heating component to start or stop working, so that a controlled temperature detected by the temperature sensing component is maintained in a first temperature interval; and control, based on a temperature detected by the temperature sensing component, the air supply component to start or stop working, so that a controlled temperature detected by the temperature sensing component is maintained in a second temperature interval. The temperature control apparatus in this application features a small volume, applicability to household purposes, easy operations, and low costs.

### TECHNICAL FIELD

Embodiments of the present disclosure relate to the field of household appliance technologies, and in particular, to a temperature control apparatus and a fermented tea manufacturing method.

### BACKGROUND

Fermented tea is a drink containing beneficial microorganisms (such as lactic acid bacteria and yeast), and is favored by many users.

In an existing fermented tea manufacturing method, water is usually boiled by using a kettle and the heated water is then put into another container. Subsequently, tea leaves and sugar are added into the container. When it is manually detected that the liquid in the container is cooled to a specific temperature, enzymes are added to prepare fermented tea, and no other treatment is performed in the fermented tea preparation process. Therefore, approximately one month is needed to complete the fermented tea preparation. In addition, the fermented tea preparation often fails due to an excessively high or low ambient temperature during a fermentation process. This manufacturing method is relatively complex and requires a relatively long fermentation time for completion. Consequently, fermented tea preparation efficiency and a fermented tea preparation success rate are reduced.

### SUMMARY

Embodiments of this present disclosure provide a temperature control apparatus and a fermented tea manufacturing method. The temperature control apparatus features a small volume, applicability to household purposes, easy operations, and low costs. The fermented tea manufacturing method can simplify an operation in a fermented tea preparation process, and can shorten a fermentation time through constant temperature control, thereby improving fermented tea preparation efficiency and a fermented tea preparation success rate.

According to a first aspect, an embodiment of this present disclosure provides a temperature control apparatus, including a base housing, a controller, a heating component, an air supply component, and a temperature sensing component, where the controller, the heating component, and the air supply component are disposed in an inner cavity of the base housing;

the controller is electrically connected to the heating component; the controller is electrically connected to the air supply component; and the controller is electrically connected to the temperature sensing component; and

the controller is configured to perform temperature control, and is specifically configured to:

control, based on a temperature detected by the temperature sensing component, the heating component to start or stop working, so that a controlled temperature detected by the temperature sensing component is maintained in a first temperature interval; and

control, based on a temperature detected by the temperature sensing component, the air supply component to start or stop working, so that a controlled temperature detected by the temperature sensing component is maintained in a second temperature interval.

In the first aspect, the temperature control apparatus features a small volume, applicability to household purposes, easy operations, and low costs. In addition, the heating component and the air supply component may be used to implement temperature control, and a temperature can be more accurately controlled.

According to a second aspect, an embodiment of this present disclosure provides a temperature control apparatus, including a base housing, a controller, a heating component, a pH sensing component, and a temperature sensing component, where the controller and the heating component are disposed in an inner cavity of the base housing;

the controller is electrically connected to the heating component; the controller is electrically connected to the pH sensing component; and the controller is electrically connected to the temperature sensing component;

the controller is configured to perform temperature control, and is specifically configured to:

control the heating component to start or stop working, so that a controlled temperature detected by the temperature sensing component is maintained in a first temperature interval; and

the controller is configured to stop temperature control if a pH value detected by the pH sensing component falls in a first pH value interval.

In the second aspect, the temperature control apparatus features a small volume, applicability to household purposes, easy operations, and low costs. In addition, the heating component may be used to implement temperature control, and whether to perform temperature control may be determined based on a pH value detected by a pH sensor, thereby improving intelligence of the temperature control apparatus.

According to a third aspect, an embodiment of this present disclosure provides a temperature control apparatus, including a base housing, a controller, a heating component, and a temperature sensing component, where the controller and the heating component are disposed in an inner cavity of the base housing;

the controller is electrically connected to the heating component; and the controller is electrically connected to the temperature sensing component;

the controller is configured to perform temperature control, and is specifically configured to:

control, based on a temperature detected by the temperature sensing component, the heating component to start or stop working, so that a controlled temperature detected by the temperature sensing component is maintained in a first temperature interval; and

the controller is configured to stop temperature control if first constant temperature duration in which the controller performs temperature control is not less than preset constant temperature duration; where

the preset constant temperature duration is determined based on a constant temperature duration operation performed by a user on the temperature control apparatus, or is determined based on constant temperature duration operation information sent by a target terminal, or is default constant temperature duration of the temperature control apparatus.

In the third aspect, the temperature control apparatus features a small volume, applicability to household purposes, easy operations, and low costs. In addition, the heating component may be used to implement temperature control, and whether to perform temperature control may be determined based on temperature control execution duration, thereby improving intelligence of the temperature control apparatus.

According to a fourth aspect, an embodiment of this present disclosure provides a fermented tea manufacturing method, where fermented tea is prepared by using a temperature control apparatus in the method, and the temperature control apparatus includes a kettle configured to accommodate liquid and a base; and the method includes:

a first stage: heating water accommodated in the kettle, and stopping heating when a temperature of the water falls in a first temperature interval;

a second stage: adding tea leaves into the kettle at a first moment, taking out the tea leaves after a first time period following the addition, and adding sugar into the kettle at a second moment to form a first liquid;

a third stage: when a cooled temperature of the first liquid falls in a second temperature interval, adding a ferment substance including enzymes to the first liquid to form a second liquid; and

a fourth stage: controlling a temperature of the second liquid, so that the temperature of the second liquid is maintained in the second temperature interval for 3 to 21 days, to obtain fermented tea.

In this embodiment of this present disclosure, in the fermented tea preparation process, the temperature of the liquid to which the ferment substance is added may be adjusted, so that the temperature of the liquid is maintained in a constant temperature interval. In this way, a fermentation time is shortened through constant temperature control, and fermented tea preparation efficiency and a fermented tea preparation success rate are improved. In addition, a user does not need to pour the liquid from one container to another, and operations are simple and facilitate use by the user.

### BRIEF DESCRIPTION OF DRAWINGS

To describe the technical solutions in the embodiments of this present disclosure more clearly, the following describes the accompanying drawings required for describing the embodiments of the present disclosure.

FIG. 1a is a structural example diagram of a temperature control apparatus according to one or more embodiments of the present disclosure;

FIG. 1B is a structural example diagram of a temperature control apparatus according to one or more embodiments of the present disclosure;

FIG. 1c is a structural example diagram of a temperature control apparatus according to one or more embodiments of the present disclosure;

FIG. 2 is a structural example diagram of different components of a temperature control apparatus according to one or more embodiments of the present disclosure.

FIG. 3 is a structural example diagram of a kettle according to one or more embodiments of the present disclosure.

FIG. 4A is a structural example diagram of an air flow transfer housing according to one or more embodiments of the present disclosure.

FIG. 4B is a structural example diagram of another air flow transfer housing according to one or more embodiments of the present disclosure.

FIG. 5 is a structural example diagram of a temperature control apparatus according to one or more embodiments of the present disclosure.

FIG. 6A is a structural example diagram of a temperature control apparatus having a temperature sensing component according to one or more embodiments of the present disclosure.

FIG. 6B is a structural example diagram of a temperature sensing component according to one or more embodiments of the present disclosure.

FIG. 6C is a structural example diagram of a peripheral component according to one or more embodiments of the present disclosure.

FIG. 7A is an example diagram of function keys for example 1 according to one or more embodiments of the present disclosure.

FIG. 7B is an example diagram of a function key for example 4 according to one or more embodiments of the present disclosure.

FIG. 8 is a schematic structural diagram of a temperature control apparatus according to one or more embodiments of the present disclosure.

FIG. 9 is a schematic flowchart of a fermented tea manufacturing method according to one or more embodiments of the present disclosure.

### DESCRIPTION OF EMBODIMENTS

The following describes the embodiments of this present disclosure with reference to the accompanying drawings in the embodiments of this present disclosure. Examples of the embodiments are illustrated in the accompanying drawings. Reference signs that keep the same or similar from beginning to end represent the same or similar elements or elements with same or similar functions. The embodiments described below with reference to the accompanying drawings are examples and merely intended for explaining this present disclosure, and should not be construed as a limitation on this present disclosure.

It should be understood that, in description of this present disclosure, directions or positional relations indicated by terms such as “length”, “width”, “up”, “down”, “before”, “after”, “left”, “right”, “vertical”, “horizontal”, “top”, “bottom”, “inside”, and “outside” are the directions or positional relations based on the accompanying drawings, which are just to describe the this present disclosure easily and simplify the description, but do not indicate or imply that the referred apparatus or element must have a specific orientation and make construction and operations in the specific orientation, so they shall not be understood as a limitation on this present disclosure.

In addition, the terms “first” and “second” are merely intended for a purpose of description, and shall not be understood as an indication or implication of relative importance or implicit indication of the number of indicated technical features. Therefore, a feature limited by “first” or “second” may explicitly or implicitly include one or more features. In the description of this present disclosure, “a plurality of” means at least two, unless otherwise specifically limited. “At least one of A, B, and C” means selecting any one from the following seven combinations: (A, B, C), (A, B), (A, C), (B, C), (A), (B), and (C).

In the description of this present disclosure, terms “installation”, “joint”, and “connection” should be understood in a broader sense unless otherwise explicitly stipulated and limited. For example, “connection” may be a fixed connection, a detachable connection, or an integrated connection; a mechanical connection or an electrical connection; or a direct connection, a connection through an intermediate medium, or a connection inside two elements or an interaction relationship between two elements. For a person of ordinary skill in the art, specific meanings of the foregoing terms in this present disclosure can be understood based on a specific situation.

Proper nouns in the embodiments of this present disclosure include:

pH: a hydrogen ion concentration, which is a ratio of a total quantity of hydrogen ions in a solution to a total amount of matter.

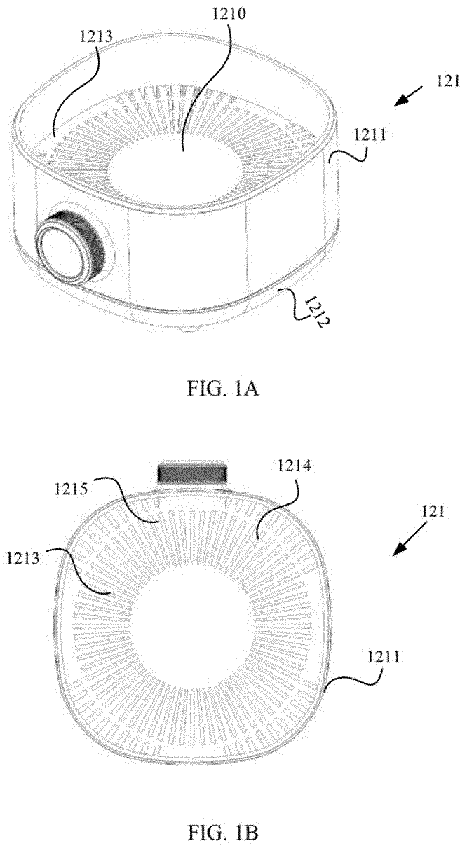

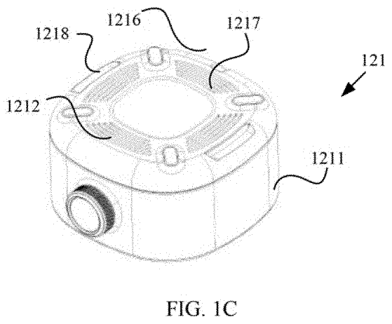

FIGS. 1A to 1C are structural example diagrams of a temperature control apparatus 1 according to one or more embodiments of the present disclosure.

The temperature control apparatus 1 includes a base housing 121, a controller 122, a heating component 123, an air supply component 124, and a temperature sensing component 13. The controller 122 is electrically connected to the heating component 123. The controller 122 is electrically connected to the air supply component 124. The controller 122 is electrically connected to the temperature sensing component. The controller 122 is configured to perform temperature control. A specific operation of the controller 122 can be as follows: controlling, based on a temperature detected by the temperature sensing component, the heating component 123 to start or stop working, so that a first controlled temperature detected by the temperature sensing component is maintained in a first temperature interval; and controlling, based on a temperature detected by the temperature sensing component, the air supply component 124 to start or stop working, so that a second controlled temperature detected by the temperature sensing component is maintained in a second temperature interval.

Specifically, the controller 122, the heating component 123, and the air supply component 124 are all disposed in an inner cavity of the base housing 121. In this way, the controller 122, the heating component 123, and the air supply component 124 are not exposed to the outside of the base housing 121, and a user is prevented from directly touching the components.

The base housing 121 includes a first housing 1211 and a support component 1212. The support component 1212 is connected to the first housing 1211 in a manner of a buckle connection, an adhesive connection, or a screw-based fastened connection. The manner of connection between the support component 1212 and the first housing 1211 is not limited in this embodiment of this present disclosure. The foregoing inner cavity of the base housing 121 is space between a heat conducting plate 1210 and the support component 1212.

In FIG. 1A, a part of an upper surface of the base housing 121 includes the heat conducting plate 1210. The heat conducting plate 1210 is in contact with the heating component 123, and is configured to conduct heat generated by the heating component 123. Further, the heating component 123 includes a heating tube 1231 (or referred to as a heater tube). The heating tube 1231 is fixedly connected to the heat conducting plate 1210, for example, by directly casting the heating tube inside the heat conducting plate. The heat conducting plate 1210 may be a stainless steel material, an aluminum alloy material, or the like. A material, a shape, and a position of the heat conducting plate 1210 are not limited in this present disclosure. The heating tube 1231 may include a seamless metal tube (for example, a carbon steel tube, a titanium tube, a stainless steel tube, a copper tube, or the like) and an electric wire. A material, a shape, and a composition manner of the heating tube 1231 are not limited in this present disclosure. The upper surface of the base housing 121 is configured to place a kettle 11. The upper surface of the heat conducting plate 1210 is directly in contact with a bottom of the kettle 11, so as to heat a liquid accommodated in the kettle 11.

The heat conducting plate 1210 is fastened to the first housing 1211 by using a connector 1213. Referring to FIG. 1B, one or more air outlets are disposed in the connector 1213. Referring to FIG. 1C, one or more air inlets are disposed at a bottom of the support component 1212. In this way, for the base housing 121, a second air flow passage can be formed by using the air inlet disposed on the connector 1213 and the outlet disposed on the support component 1212. FIG. 1A to FIG. 1C show merely example descriptions. With reference to the example diagrams of FIG. 1A to FIG. 1C, in a possible implementation, an air flow is transferred in the second air flow passage in an up-and-down direction. In this case, the air supply component 124 is placed below the heating component 123, so that an air flow generated by the air supply component 124 transfers out an air flow around the heating component 123 through the second air flow passage. In another possible implementation, the second air flow passage disposed in the base housing 121 does not comply with the up-and-down direction. For example, the one or more air inlets are disposed on side walls of the base housing, and when the air supply component 124 is working, an air flow may come in from the one or more air inlets and come out from the one or more air outlets. In this present disclosure, a shape of an air inlet and a quantity of the air inlets are not limited, and a shape of an air outlet and a quantity of the air outlets are not limited. In other words, this embodiment of this present disclosure sets no limitation on a structural design of the second air flow passage formed by the base housing.

Further, as shown in FIG. 1B, the plurality of air outlets disposed on the connector 1213 include a plurality of first air outlets 1214, and the first air outlets 1214 are disposed around the heat conducting plate 1210. This present disclosure sets no limitation on a quantity of the plurality of first air outlets, a shape of each first air outlet, a position of each first air outlet, and a density of the plurality of first air outlets. As shown in FIG. 1B, a plurality of first air outlets with a trapezoidal shape are evenly arranged around the heat conducting plate 1210. When the heat conducting plate 1210 is circular, the plurality of first air outlets 1214 may be arranged in a ring form to surround the heat conducting plate 1210. Optionally, the plurality of air outlets disposed on the connector 1213 may further include a plurality of second air outlets 1215. The plurality of second air outlets 1215 are disposed based on a shape of the first housing 1211. This present disclosure sets no limitation on a quantity of the plurality of second air outlets, a shape of each second air outlet, a position of each second air outlet, and a density of the plurality of second air outlets.

Further, optionally, at least two support feet 1216 are disposed at the bottom of the support component 1212, and the support component 1212 including the at least two support feet 1216 can evenly support a base 12 and the kettle 11 disposed above. The support feet 1216 can provide anti-wear and anti-shock functions, and the support component 1212 may further raise a distance between the base 12 and a plane used for placing the temperature control apparatus 1, so as to implement an air supply function, thereby further implementing effective operation of the air supply component 124. As shown in FIG. 1C, the plurality of air inlets disposed on the support component 1212 include a plurality of third air outlets 1217 and/or two fourth air outlets 1218. Each third air outlet is configured to implement air flow transfer in a vertical direction, and each fourth air outlet 1218 is configured to implement air flow transfer in a horizontal direction. This present disclosure sets no limitation on a quantity of the plurality of third air outlets, a shape of each third air outlet, a position of each third air outlet, and a density of the plurality of third air outlets. In addition, this present disclosure sets no limitation on a quantity of a plurality of fourth air outlets, a shape of each fourth air outlet, a position of each fourth air outlet, and a density of the plurality of fourth air outlets.

With the structure of the temperature control apparatus 1 in FIG. 1A to FIG. 1C, in an aspect of the controlling, based on a temperature detected by the temperature sensing component, the heating component to start or stop working, so that a first controlled temperature detected by the temperature sensing component is maintained in a first temperature interval, the controller 122 is specifically configured to: if the controller 122 determines that the temperature detected by the temperature sensing component is lower than a lowest temperature of the first temperature interval, control the heating component 123 to start working, and when the temperature detected by the temperature sensing component falls in the first temperature interval, control the heating component 123 to stop working.

In an aspect of the controlling, based on a temperature detected by the temperature sensing component, the air supply component to start or stop working, so that a controlled temperature detected by the temperature sensing component is maintained in a second temperature interval, the controller 122 is specifically configured to: if the controller 122 determines that the temperature detected by the temperature sensing component is higher than a highest temperature of the second temperature interval, control the air supply component 124 to start working, and when the temperature detected by the temperature sensing component falls in the second temperature interval, control the air supply component 124 to stop working.

For example, the temperature control apparatus 1 may be configured to heat water or another liquid. The first temperature interval is a temperature interval specified by a user through a manual operation or a remote operation. Alternatively, the first temperature interval is a default temperature interval. This embodiment of this present disclosure sets no limitation on a manner of specifying the first temperature interval. For example, for water heating, the first temperature interval is [94° C., 100° C.], water is accommodated in the kettle 11, the kettle is placed above the base housing 121, and the controller 122 controls the heating component 123 to start working and detects that a temperature of the heated water falls in the first temperature interval [94° C., 100° C.]. In this case, the controller 122 controls the heating component 123 to stop working.

For another example, the temperature control apparatus may be configured to implement a constant temperature function. The first temperature interval and the second temperature interval are the same. In this case, determining the first temperature interval is equivalent to determining both the first temperature interval and the second temperature interval. The first temperature interval is a temperature interval specified by a user through a manual operation or a remote operation. Alternatively, the first temperature interval is a default temperature interval. This embodiment of this present disclosure sets no limitation on a manner of specifying the first temperature interval. For example, constant temperature control is implemented on a liquid, and the first temperature interval is [20° C., 32° C.], the liquid is accommodated in the kettle 11, and the kettle is placed above the base housing 121. If detecting that a current temperature of the liquid is less than 20° C., the controller 122 controls the heating component 123 to start working. If detecting that a temperature of the liquid reaches [20° C., 32° C.] in a heating process, the controller 122 controls the heating component 123 to stop working. If detecting that a current temperature of the liquid is higher than 32° C., the controller 122 controls the air supply component 124 to start working. If detecting that a temperature of the liquid falls in [20° C., 32° C.] in an air supply process, the controller 122 controls the air supply component 124 to stop working. In a constant temperature control scenario, when the highest temperature of the second temperature interval is lower than a room temperature, a temperature cannot be reduced through natural cooling. In this case, use of the air supply component can accelerate cooling, improve cooling efficiency, and effectively ensure constant temperature control.

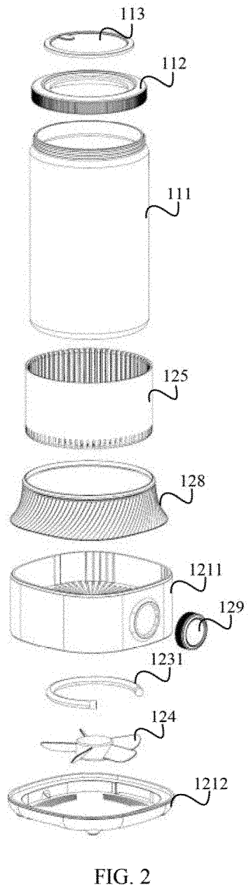

FIG. 2 is a schematic structural diagram of different components in the temperature control apparatus 1. As shown in FIG. 2, the temperature control apparatus 1 can include at least one of an air flow transfer housing 125, the kettle 11, or a display panel 129.

For description of the kettle 11, as shown in FIG. 2, the kettle 11 includes a kettle body 111 and a kettle cover 112, and the kettle cover 112 is detachably connected to the kettle body 111. This present disclosure sets no limitation on materials of the kettle body and the kettle cover. In a possible implementation, the kettle cover 112 may be connected to the kettle body 111 through a screw thread, and an opening of the kettle body 111 has a screw thread. The kettle cover 112 is also provided with a matching screw thread for fastening, so that the kettle cover 112 can be fastened to the opening of the kettle body 111. In another possible implementation, the kettle cover 112 and the kettle body 111 may be connected by using a connector, e.g., a clip, a hook, a clasp, or a buckle. This present disclosure sets no limitation on the connector used by the kettle cover 112 and the kettle body 111.

For example, in terms of an implementation of the kettle, in a fermented tea preparation scenario, the kettle body 111 is made of a glass material, and the kettle cover 112 includes an air-permeable covering component 113. A part of the kettle cover 112 other than the air-permeable covering component 113 is made of a plastic or silicone material, and the air-permeable covering component 113 may be made of a metal filter or a plastic filter or filter paper. This embodiment of this present disclosure sets no limitation thereto. Optionally, an anti-scalding layer is disposed on a touch-prone upper part of the glass kettle body, for example, an anti-scalding silicone layer, which can reduce an exposed area of the high-temperature glass kettle body. Optionally, because the kettle body 111 is the glass material, a handle may be added to the kettle body 111. FIG. 3 is a structural example diagram of a kettle according to an embodiment of the present disclosure. As shown in FIG. 3, a clamping component is disposed on an upper half of the kettle body 111 to clamp the handle 114. Optionally, in a possible implementation, clamping components may further be disposed on both the upper half and a middle part of the kettle body 111, so as to clamp the handle 114. In this way, when there is a large amount of liquid in the kettle 11, force can be applied to the handle 114 more evenly, so as to extend a service life of the handle 114.

The air flow transfer housing 125 is described below. The air flow transfer housing 125 is disposed above the base housing 121. Optionally, the temperature control apparatus 1 can further include a second housing 128, where the second housing 128 is fixedly connected to the first housing 1211, the second housing 128 may be disposed above the first housing 1211, and the second housing 128 enables the air flow transfer housing 125 to be more stably disposed above the base housing 121. This embodiment of this present disclosure sets no limitation on a structure of the second housing 128.

When the kettle 11 is placed on the upper surface of the base housing 121, the kettle 11 may be disposed at least in part in a cavity formed by the air flow transfer housing 125, and a first air flow passage exists between the air flow transfer housing 125 and an outer wall of the kettle 11, where the first air flow passage is used to transfer an air flow coming out from one or more air outlets. This embodiment of this present disclosure sets no limitation on a structural design for forming the first air flow passage and how the gap is designed between an inner wall of the air flow transfer housing 125 and a side wall of the kettle body 111. On the basis that the base 12 includes the air flow transfer housing 125, the first air flow passage can communicate with the second air flow passage.

In the aspect of the controlling the heating component 123 to start or stop working, so that a controlled temperature detected by the temperature sensing component is maintained in a first temperature interval, the controller 122 is specifically configured to: if the controller 122 determines that the temperature detected by the temperature sensing component is lower than the lowest temperature of the first temperature interval, control the heating component 123 and the air supply component 124 to start working, and when the temperature detected by the temperature sensing component falls in the first temperature interval, control the heating component 123 and the air supply component 124 to stop working. When the controller 122 starts the heating component 123 and the air supply component 124, the heating component 123 generates energy to heat the bottom of the kettle 11, and in addition, the air supply component 124 generates an air flow to transfer hot air generated by the heating component 123 to around the kettle body of the kettle 11 through the second air flow passage and the first air flow passage. In this implementation, the liquid in the kettle 11 is heated more evenly than that in a solution in which only a bottom of a kettle is heated.

Further, the air flow transfer housing 125 is described below. The air flow transfer housing 125 is an annular cylinder, to be specific, a bottom and a top of the air flow transfer housing 125 are not shielded. In this way, when the air flow transfer housing 125 is placed above the first housing 1211, the bottom of the kettle 11 may also be directly in contact with the heat conducting plate disposed in the first housing 1211. A shape of the air flow transfer housing 125 matches the kettle body 111, and this present disclosure sets no limitation on the shape of the air flow transfer housing. Next, there is the first air flow passage between the inner wall of the air flow transfer housing 125 and the kettle body 111. For example, a plurality of grooves 1251 are disposed on the inner wall of the air flow transfer housing 125, and the plurality of grooves 1251 are configured to form the first air flow passage. Optionally, the plurality of grooves 1251 are evenly distributed on the inner wall of the air flow transfer housing.

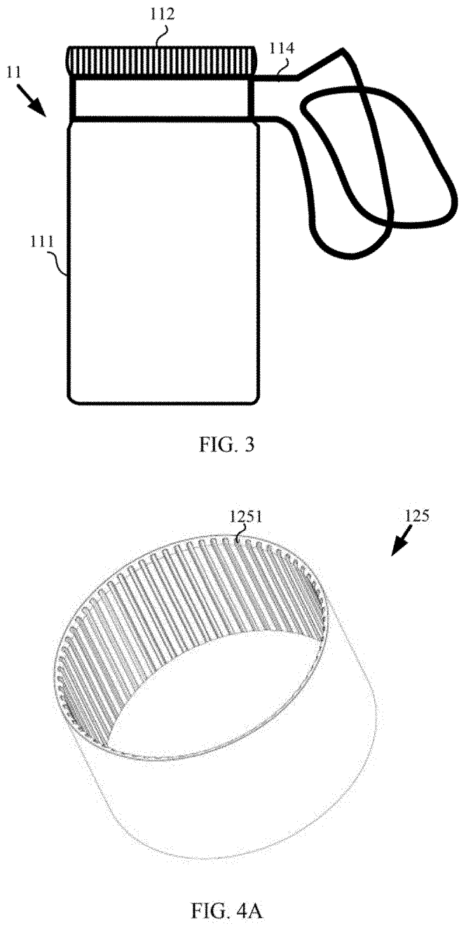

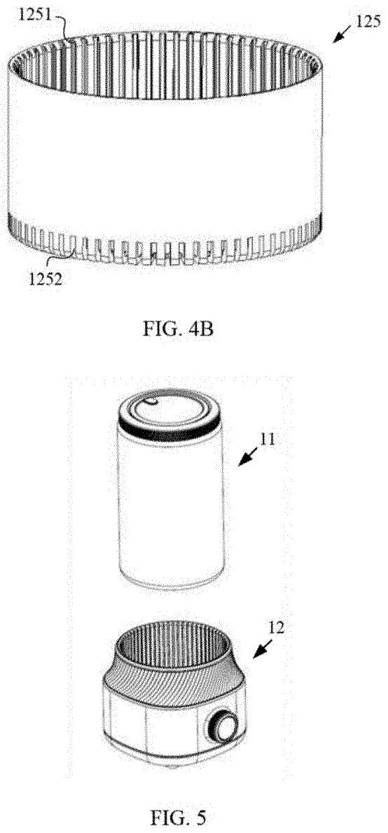

Each of FIG. 4A and FIG. 4B is a structural example diagram of an air flow transfer housing 125 according to an embodiment of this present disclosure. As shown in FIG. 4A, each groove 1251 has a vertical shape, so that the formed first air flow passage is also vertical, and an air flow may be transferred vertically upward from the bottom of the air flow transfer housing 125. Optionally, a shape of each groove 1251 is helically raised from the bottom of the air flow transfer housing 125 to the top of the air flow transfer housing 125, so that an air flow is transferred upward helically from the bottom of the air flow transfer housing 125. In this way, a residence time of the transferred air flow inside the air flow transfer housing 125 can be prolonged. This present disclosure sets no limitation on shapes and a quantity of the grooves. Further, optionally, a side wall of the kettle 11 may be as close to a groove of the air flow transfer housing 125 as possible, so that when the first air flow passage is formed, the kettle 11 accommodating a liquid may be more stable and does not easily shake.

Further, referring to FIG. 4B, the air flow transfer housing 125 in FIG. 4B can be further provided with a plurality of holes 1252 in a lower half of the housing. This present disclosure sets no limitation on a quantity of the plurality of holes, a shape of each hole, a position of each hole, and a density of the plurality of holes.

With reference to FIG. 4B, when there are only a plurality of first air outlets 1214 disposed on the connector 1213, a structure of the air flow transfer housing 125 may be the example structure shown in FIG. 4A, and a ring formed by the plurality of first air outlets 1214 partially overlaps the first air flow passage. Therefore, the second air flow passage communicates with the first air flow passage. When the plurality of air outlets disposed on the connector 1213 include a plurality of first air outlets 1214 and a plurality of second air outlets 1215, a structure of the air flow transfer housing 125 may be the example structure shown in FIG. 4B, so that an air flow transferred by the plurality of second air outlets 1215 can be transferred by using the plurality of holes 1252 in the air flow transfer housing in FIG. 4B, and the air flow can be transferred to the first air flow passage more quickly.

It should be noted that “the second air flow passage communicates with the first air flow passage” described in this embodiment of this present disclosure specifically indicates that an air flow from the second air flow passage can be transferred to the first air flow passage.

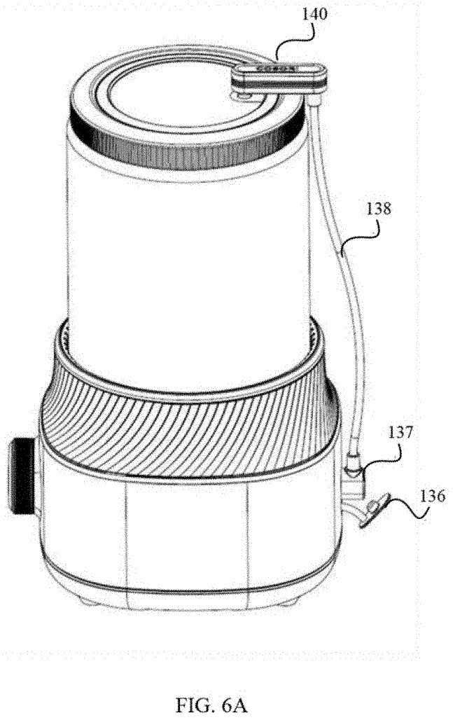

Further, as shown in FIG. 5, the temperature control apparatus 1 includes a kettle 11 and a base 12. The base 12 may include a base housing 121, a controller 122, a heating component 123, an air supply component 124, and a temperature sensing component, and may optionally further include an air flow transfer housing 125, a second housing 129, a display panel 129, and the like. In the embodiment shown in FIG. 5, the kettle 11 and the base 12 are detachable. In another possible implementation, the kettle 11 and the base 12 may further be fixedly connected. This embodiment of this present disclosure sets no limitation thereto.

Further, the temperature sensing component can include a temperature sensor 127, and the temperature sensor 127 can be electrically connected to the controller 122. The temperature sensor 127 can be disposed in an inner cavity of the base housing 121, and touch a heat conducting plate 1210 to detect a conducted temperature. The temperature sensor 127 is configured to more accurately measure a current temperature of a liquid in the kettle 11. The temperature sensor may be disposed in a position near a bottom of the kettle 11. In this embodiment of this present disclosure, the controller 122 may determine the current temperature of the liquid in the kettle 11 according to a preset calculation rule based on a temperature detected by the temperature sensor. The preset calculation rule may be performing compensation on the basis of a detected temperature, and this embodiment of this present disclosure sets no limitation on the preset calculation rule.

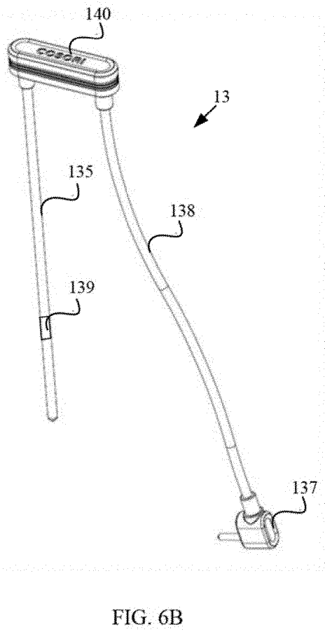

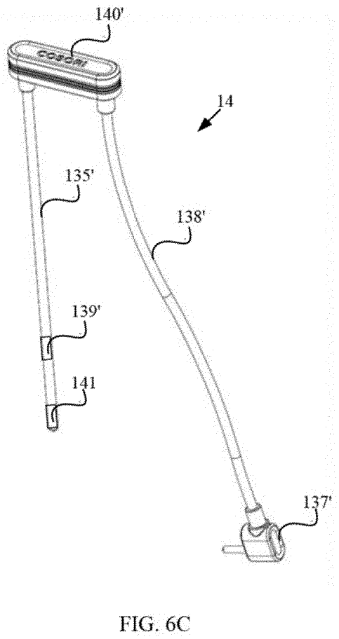

Optionally, the temperature sensing component may further include a temperature sensing component 13. FIG. 6A is a structural example diagram of a temperature control apparatus having a temperature sensing component 13 according to an embodiment of this present disclosure. FIG. 6B is a structural example diagram of a temperature sensing component according to an embodiment of this present disclosure.

As shown in FIG. 6A, the base 12 of the temperature control apparatus 1 can further include a first communications interface (not shown) and an extensible snap-on cover 136. The first communications interface is electrically connected to the controller 122. The base housing 121 is provided with a hole at a corresponding position of the first communications interface, and the hole of the base housing matches a size of the snap-on cover 136. The snap-on cover 136 may be fastened to the corresponding hole without being connected to the temperature sensing component 13.

The following describes the temperature sensing component 13. As shown in FIG. 6B, the temperature sensing component 13 can include a third communications interface 137, a communications data line 138, and a temperature sensor 139. The third communications interface 137 is connected to the temperature sensor 139 by using the communications data line 138. When the snap-on cover 136 does not cover the hole on the base housing, the third communications interface 137 of the temperature sensing component 13 may be connected to the first communications interface of the base 12. The temperature sensing component 13 can further include a tube 135, and the tube 135 may extend into the inside of the kettle 11 through an opening disposed on the kettle cover 112. A size of the opening disposed on the kettle cover 112 can be greater than or equal to a maximum cross-sectional area of the tube 135, so that the tube 135 can successfully extend into the inside of the kettle 11 through this opening.

The temperature sensor 139 shown in FIG. 6B can be a non-contact temperature sensor, and the temperature sensor 139 may be fixed in an inner cavity of the tube 135. When a part of the tube 135 enclosing the temperature sensor 139 is immersed in a liquid accommodated in the kettle 11, the temperature sensor 139 may detect a temperature of the liquid, and send the measured temperature to the controller 122. The non-contact temperature sensor 139 may be fixed in a lower middle part of the tube 135. This embodiment of this present disclosure sets no limitation on a specific position of the non-contact temperature sensor 139.

In an implementation different from that shown in FIG. 6B, the temperature sensor 139 may alternatively be a contact-type temperature sensor. The temperature sensor 139 may be a stainless steel material, and the temperature sensor 139 is externally disposed at a lowermost end of the tube 135, with the communications data line 138 placed inside the tube 135. When the temperature sensor 139 is immersed in a liquid accommodated in the kettle 11, the temperature sensor 139 can detect a temperature of the liquid, and send the measured temperature to the controller 122. In addition, the lowermost end of the tube 135 can be tightly attached to the temperature sensor 139 to prevent a liquid from entering the tube 135.

Further, the temperature sensing component 13 can further include a fastening component 140, and the fastening component 140 is configured to control the temperature sensing component 13 to be balanced on the kettle cover 112.

In some implementations, if the controller 122 establishes a communication connection to each of the temperature sensor 127 and the temperature sensing component 13, the controller 122 performs control with reference to a temperature detected by the temperature sensing component 13. If the controller 122 establishes a communication connection only to the temperature sensor 127, and the controller 122 does not establish a communication connection to the temperature sensing component 13, the controller 122 performs control with reference to a temperature detected by the temperature sensor 127.

For example, the temperature control apparatus 1 may include two working modes, for example, a normal mode and a precise mode. If the controller 122 performs control with reference to the temperature detected by the temperature sensor 127, it may be indicated that the temperature control apparatus 1 works in the normal mode. If the controller 122 performs control with reference to the temperature detected by the temperature sensing component 13, it may be indicated that the temperature control apparatus 1 works in the precise mode. The two modes are set because the temperature sensing component 13 detects a more precise temperature than the temperature sensor 127. In a specific implementation, the normal mode or the precise mode may be indicated by using an indicator, or may be displayed on the display panel 129 of the temperature control apparatus.

Further, optionally, the temperature control apparatus can further include a wireless communications module 803. The temperature control apparatus may establish a communication connection to a target terminal by using the wireless communications module 803. In this way, the temperature control apparatus may send a notification message or a reminder message to the target terminal. The user may also send a remote operation message to the temperature control apparatus by using the target terminal so as to control the temperature control apparatus. For example, remote operation information may include at least one of the following: a selection of a water heating function, a selection of a constant temperature control function, a selection of a first target temperature (or a selection of a first temperature interval), a selection of a second target temperature (or a selection of a second temperature interval), a selection of a first pH value interval, a selection of a second pH value interval, and a selection of preset constant temperature duration. The wireless communications module 803 can be disposed in the base 12, and be electrically connected to the controller 122. The controller 122 can be further configured to send at least one of a detected temperature, a detected pH value, first constant temperature duration, or a remaining constant temperature duration to the target terminal at a preset time interval by using the wireless communications module, where the remaining constant temperature duration is a difference obtained by subtracting the first constant temperature duration from the preset constant temperature duration.

The controller can be further configured to receive temperature interval operation information, pH value interval operation information, constant temperature duration operation information, and temperature control stop information by using the wireless communications module.

Further, optionally, the temperature control apparatus can further include a pH sensing component. The base 12 can further include the first communications interface. The pH sensing component can include a second communications interface. The first communications interface can be connected to the second communications interface, so that the pH sensing component is electrically connected to the controller 122. The pH sensing component can include a pH sensor and a communications data line. The second communications interface and the pH sensor of the pH sensing component can extend into the inside of the kettle 11 to detect a pH value of a liquid accommodated in the kettle 11. In other words, the pH sensing component can be equivalent to a peripheral of the temperature control apparatus. The pH value of the liquid accommodated in the kettle can be detected by establishing a communication connection between the pH sensing component and the temperature control apparatus. In the temperature control apparatus 1, the controller 122 can be configured to stop temperature control if a pH value detected by the pH sensing component falls in the first pH value interval. The controller 122 can be further configured to remind the user if the pH value detected by the pH sensing component falls in the second pH value interval. The first pH value interval and the second pH value interval are different. For example, when the temperature control apparatus is configured to prepare fermented tea, the first pH value interval can be [2, 2.5], and the second pH value interval can be [4.5, 7], [3.5, 4.5), or [2.5, 3.5). In this way, if the pH value detected by the pH sensing component falls in [4.5, 7], the controller 122 may remind the user to continue to add a ferment substance; if the pH value detected by the pH sensing component falls in [3.5, 4.5), the controller 122 may remind the user that the user may choose to continue fermentation; if the pH value detected by the pH sensing component falls in [2.5, 3.5), the controller 122 may remind the user that the user may choose to stop fermentation; and if the pH value detected by the pH sensing component falls in [2, 2.5], the controller 122 stops temperature control, that is, stops fermentation.

In a possible implementation, the pH sensing component may independently establish a communication connection to the temperature control apparatus, so as to detect a pH value.

In another possible implementation, the pH sensing component may be jointly disposed with the temperature sensing component 13. For example, a component obtained through the joint disposing is represented by a peripheral component. The peripheral component may also establish a connection to the temperature control apparatus in the manner shown in FIG. 6A. In this manner, the peripheral component is equivalent to the temperature sensing component 13 in FIG. 6A. For the base 12 of the temperature control apparatus, refer to the description in FIG. 6A. Details are not described herein again. FIG. 6C is a schematic structural diagram of a peripheral component according to an embodiment of this present disclosure. As shown in FIG. 6C, a peripheral component 14 includes a second communications interface 137′, a communications data line 138′, a temperature sensor 139′, a pH sensor 141, and a tube 135′. The temperature sensor 139′ is fixed in an inner cavity of the tube 135′. The temperature sensor 139′ may be a non-contact temperature sensor. The pH sensor 141 or a probe of the pH sensor 141 is externally disposed at a lowermost end of the tube 135′. The communications data line 138′ is disposed inside the tube 135′, and the tube 135′ may extend into the inside of the kettle 11 through the opening disposed on the kettle cover 112. When the snap-on cover 136 does not cover the hole on the base housing, the second communications interface 137′ of the peripheral component 14 may be connected to the first communications interface of the base 12.

The second communications interface 137′ is connected to the temperature sensor 139′ by using the communications data line 138′, and the second communications interface 137′ is connected to the pH sensor 141 by also using the communications data line 138′. When a portion of the tube enclosing the temperature sensor 139′ is immersed in a liquid accommodated in the kettle 11, the temperature sensor 139′ may detect a temperature of the liquid, and send the measured temperature to the controller 122, and the pH sensor 141 may detect a pH value of the liquid, and send the measured data to the controller 122. The lowermost end of the tube 135′ can be tightly attached to the pH sensor 141 to prevent the liquid from entering the tube 135′. The non-contact temperature sensor 139′ may be fixed to a lower middle part of the tube 135′. This embodiment of this present disclosure sets no limitation on a specific position of the non-contact temperature sensor 139′. A size of the opening disposed on the kettle cover 112 can be greater than or equal to a maximum cross-sectional area of the tube 135′, so that the tube 135′ can successfully extend into the inside of the kettle 11 through this opening.

Further, the peripheral component 14 can further include a fastening component 140′, and the fastening component 140′ can be configured to control the peripheral component 14 to be balanced on the kettle cover 112.

In some implementations, if the controller 122 establishes a communication connection to each of the temperature sensor 127 and the peripheral component 14, the controller 122 performs control with reference to a temperature detected by the peripheral component 14.

Further, optionally, in the foregoing scheme including the pH sensing component, the controller 122 may determine, based on the detected pH value, whether to stop temperature control. Alternatively, in another solution, the controller 122 may determine, based on the first constant temperature duration in which temperature control is performed, whether to stop temperature control. Specifically, the controller 122 is configured to stop temperature control if the first constant temperature duration in which the controller 122 performs temperature control is not less than the preset constant temperature duration. The preset constant temperature duration is determined based on a constant temperature duration operation performed by the user on the temperature control apparatus, or is determined based on constant temperature duration operation information sent by the target terminal, or is default constant temperature duration of the temperature control apparatus. For example, the preset constant temperature duration is 7 days or 200 hours. Optionally, in a scenario in which the user does not manually operate the temperature control apparatus or does not remotely set the preset constant temperature duration by using the target terminal, the temperature control apparatus may select the default constant temperature duration to perform constant temperature control. If the user manually operates the temperature control apparatus or remotely sets the preset constant temperature duration by using the target terminal, the temperature control apparatus performs constant temperature control based on the preset constant temperature duration specified by the user. This present disclosure sets no limitation on a manner of setting the preset constant temperature duration and a specific value.

Further, in a scenario in which there is the pH sensing component and the first constant temperature duration for performing temperature control is determined, a specific implementation in which the controller 122 performs temperature control is as follows: The controller 122 stops temperature control if the pH value detected by the pH sensing component falls in the first pH value interval and the first constant temperature duration in which the controller 122 performs temperature control is not less than the preset constant temperature duration. If the pH value detected by the pH sensing component does not fall in the first pH value interval and the first constant temperature duration in which the controller 122 performs temperature control is not less than the preset constant temperature duration, the controller 122 is further configured to send a reminder message notifying that the temperature control is stoppable by using the wireless communications module. If the pH value detected by the pH sensing component falls in the first pH value interval and the first constant temperature duration in which the controller 122 performs temperature control is less than the preset constant temperature duration, the controller 122 is further configured to send a reminder message by using the wireless communications module. The reminder message can be used to notify the user that the temperature control is stoppable or that the user can choose to stop the temperature control or continue the temperature control. If the pH value detected by the pH sensing component does not fall in the first pH value interval and the first constant temperature duration in which the controller 122 performs temperature control is less than the preset constant temperature duration, the controller 122 is further configured to continue temperature control. The reminder message herein may be used to notify that the user may choose to stop or continue temperature control. After sending the reminder message and before receiving feedback from the user, the controller 122 continues to perform temperature control. If the controller 122 receives a feedback message indicating that the user chooses to stop temperature control, the controller 122 stops temperature control.

Based on the temperature control apparatus described above, the following describes functions that can be implemented by the temperature control apparatus by using function keys.

In a possible implementation, the base 12 of the temperature control apparatus includes at least one control function key and a first selection function key. The first selection function key is used to select a temperature. The following examples 1 to 3 are used for description.

Example 1: The base 12 includes a water heating function key, a constant temperature control function key, and the first selection function key. After enabled, the water heating function key is configured to heat the liquid in the kettle 11 if a first target temperature is not further selected on the first selection function key, and stop heating when a temperature of the liquid reaches a first default temperature interval; or is further configured to determine the first temperature interval if a first target temperature is further selected on the first selection function key and heat the liquid in the kettle 11, and stop heating when a temperature of the liquid reaches the first temperature interval. After enabled, the constant temperature control function key is configured to: if a second target temperature is not further selected on the first selection function key, perform constant temperature control on the liquid in the kettle 11, so that a temperature of the liquid is maintained in a second default temperature interval; or is further configured to: if a second target temperature is further selected on the first selection function key, determine the second temperature interval and perform constant temperature control on the liquid in the kettle 11, so that a temperature of the liquid is maintained in the second temperature interval.

Example 2: The base 12 includes a water heating function key and a first selection function key. After enabled, the water heating function key is configured to heat the liquid in the kettle 11 if a first target temperature is not further selected on the first selection function key, and stop heating when a temperature of the liquid reaches a first default temperature interval; or is further configured to determine the first temperature interval if a first target temperature is further selected on the first selection function key and heat the liquid in the kettle 11, and stop heating when a temperature of the liquid reaches the first temperature interval. In addition, after the heating ends, the temperature control apparatus performs constant temperature control on the liquid in the kettle 11, so that a temperature of the liquid is maintained in a second default temperature interval.

Example 3: The base 12 includes a constant temperature control function key and a first selection function key. After enabled, the constant temperature control function key is configured to first heat a liquid, specifically, heat the liquid in the kettle 11, and stop heating when a temperature of the liquid reaches a first default temperature interval. Subsequently, after the heating, if a second target temperature is not further selected on the first selection function key after the constant temperature control function key is enabled, the constant temperature control function key is configured to perform constant temperature control on the liquid in the kettle 11, so that a temperature of the liquid is maintained in a second default temperature interval; or if a second target temperature is further selected on the first selection function key after the constant temperature control function key is enabled, the constant temperature control function key is configured to determine the second temperature interval and perform constant temperature control on the liquid in the kettle 11, so that a temperature of the liquid is maintained in a second temperature interval.

In the foregoing example 1, example 2, or example 3, optionally, the control function key that may be further included on the base 12 of the temperature control apparatus is an on/off function key. The on/off function key is configured to control whether to power on the temperature control apparatus. If the on function key is enabled, the temperature control apparatus is powered on. If the off function key is enabled, the temperature control apparatus is powered off. After power-on, operations may be performed by using the control function key and the first selection function key in the foregoing examples.

In the foregoing example 1, example 2, or example 3, optionally, the control function key that may be further included on the base 12 of the temperature control apparatus is a constant temperature duration function key. In addition, the first selection function key may be further configured to select the preset constant temperature duration, where the preset constant temperature duration is preset duration for performing constant temperature control. The constant temperature duration function key is configured to set the preset constant temperature duration. After the constant temperature duration function key is enabled, the first selection function key may be used to select desired preset constant temperature duration.

In the foregoing example 1, example 2, or example 3, optionally, the temperature control apparatus may further include a normal/precise mode indication. For details, refer to the descriptions in FIG. 6A and FIG. 6B.

In another possible implementation, the base 12 of the temperature control apparatus includes a second selection function key. The second selection function key is described by using the following example 4.

Example 4: The second selection function key is configured to select a target fermentation mode, where the target fermentation mode is any one of a plurality of preset fermentation modes. The fermentation modes are corresponding to types of tea leaves. Specifically, the plurality of fermentation modes may include at least one of the following modes: a green tea fermentation mode, a black tea fermentation mode, a white tea fermentation mode, an oolong tea fermentation mode, or the like. In addition, a first temperature interval and a second temperature interval that are corresponding to each fermentation mode are preset. The first temperature interval is used to indicate a temperature interval that a water temperature needs to reach in a water heating process. The second temperature interval is used to indicate a temperature interval in which a temperature needs to be maintained in a constant temperature control process. Optionally, preset constant temperature duration corresponding to the target fermentation mode may be specified in advance, and after the target fermentation mode is selected, constant temperature control is performed based on the preset constant temperature duration corresponding to the target fermentation mode. The preset constant temperature duration corresponding to each fermentation mode may be different, and this embodiment of this present disclosure sets no limitation thereto. In the manner of example 4, fermented tea can be prepared through one-click selection, which reduces a user operation and enhances user stickiness.

In the foregoing example 4, optionally, the base 12 of the temperature control apparatus may further include an on/off function key. The on/off function key is configured to control whether to power on the temperature control apparatus. If the on function key is enabled, the temperature control apparatus is powered on. If the off function key is enabled, the temperature control apparatus is powered off. After power-on, an operation may be performed by using the second selection function key in the foregoing example.

In the foregoing example 4, optionally, the base 12 of the temperature control apparatus may further include a constant temperature duration function key. The second selection function key may be further configured to select the preset constant temperature duration. The preset constant temperature duration is preset duration for performing constant temperature control. The constant temperature duration function key is configured to set the preset constant temperature duration. After the constant temperature duration function key is enabled, the second selection function key may be used to select desired preset constant temperature duration.

In the foregoing example 4, optionally, the temperature control apparatus may further include a normal/precise mode indication. For details, refer to the descriptions in FIG. 6A and FIG. 6B.

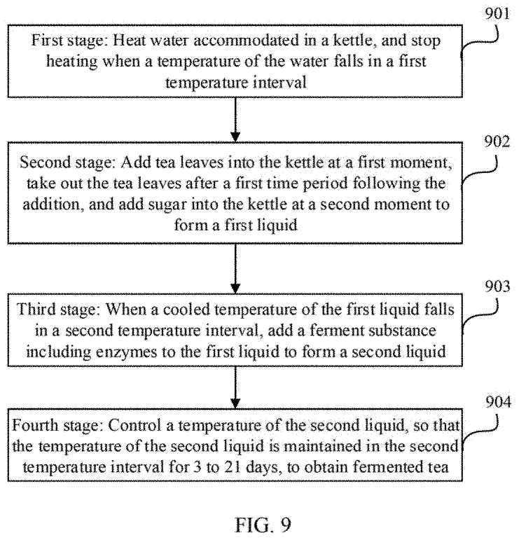

It should be noted that specific values of the first target temperature, the second target temperature, the first temperature interval, the second temperature interval, the first default temperature interval, and the second default temperature interval in the foregoing designs are not limited. For example, for a value of each parameter, refer to description in an embodiment in FIG. 9.

There is a corresponding indicator for each function key described above. An on/off indicator can indicate whether a function corresponding to the function key is working. For example, when a function corresponding to a function key is in a working state, an indicator is on; or when a function corresponding to a function key is in a working-stopped state, an indicator is off. In addition, optionally, different function keys may correspond to indicators of different colors. This present disclosure sets no limitation on a color of an on indicator corresponding to each function key. In addition, it should be noted that any one of the foregoing function keys may be enabled or disabled in an entity key manner or a touchscreen operation manner. The first selection function key and the second selection function key may implement selection functions in a rotary knob manner. Alternatively, the first selection function key and the second selection function key may implement selection functions in the entity key manner or the touchscreen operation manner. Alternatively, power is on and a function of the water heating function key is enabled when the kettle 11 accommodating a liquid is placed on the base housing 121, and power is off when the kettle 11 accommodating a liquid is removed from the base housing 121. This embodiment of this present disclosure sets no limitation on how to enable/disable a function key.

Further, the temperature control apparatus 1 may further include the display panel 129, and the controller 122 is electrically connected to the display panel 129. The display panel 129 may be configured to display a temperature of a current liquid. In an optional implementation, in the foregoing description, the temperature control apparatus includes at least a selection function key. If the selection function key is in the rotary knob manner, the display panel is located on a disk of the first selection function key or the second selection function key. In another optional implementation, the display panel may be disposed on the base housing 121 for viewing by a user. This embodiment of this present disclosure sets no limitation on a setting position of the display panel.

In the foregoing example 1, a selected temperature may be displayed in real time depending on a temperature selection of the user, and a finally selected first target temperature and second target temperature may be displayed. In the foregoing example 2, a selected temperature may be displayed in real time depending on a temperature selection of the user, and a finally selected first target temperature may be displayed. Optionally, a stage of a current moment may be further displayed based on a fermented tea preparation process, for example, a water heating stage or a constant temperature control stage may be displayed. In the foregoing example 3, a selected temperature may be displayed in real time depending on a temperature selection of the user, and a finally selected second target temperature may be displayed. Optionally, a stage of a current moment may be further displayed based on a fermented tea preparation process, for example, a water heating stage or a constant temperature control stage may be displayed. In addition, in a scenario with the pH sensing component, a detected pH value may be displayed.

In the foregoing example 1, example 2, or example 3, when there is the constant temperature duration function key, the first constant temperature duration or the remaining constant temperature duration may be further displayed. The remaining constant temperature duration is a difference obtained by subtracting the first constant temperature duration from the preset constant temperature duration.

In the foregoing example 4, a target fermentation mode may be further displayed. Optionally, a stage of a current moment may be further displayed based on a fermented tea preparation process, for example, a water heating stage or a constant temperature control stage may be displayed.

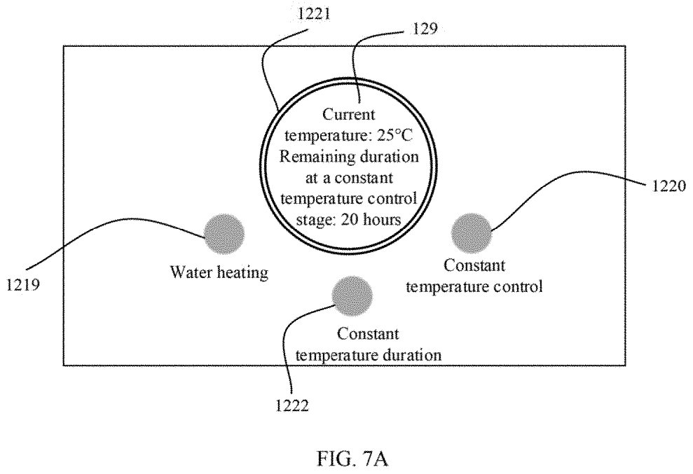

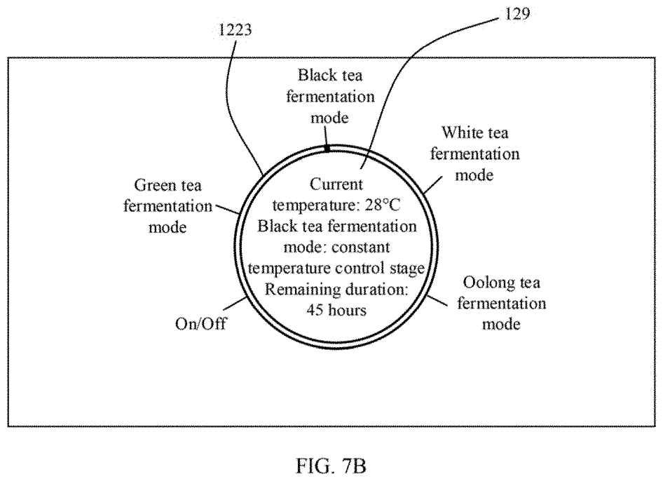

The following uses specific examples to illustrate the foregoing examples 1 to 4. FIG. 7A is an example diagram of function keys for example 1 according to an embodiment of this present disclosure. The example diagram only shows a partial front view of the first housing 1211. The example diagram includes a water heating function key 1219, a constant temperature control function key 1220, a first selection function key 1221, a constant temperature duration function key 1222, and the display panel 129. These function keys can implement the implementation functions described in example 1, and display a selected temperature on the display panel 129 in real time depending on a temperature selection of the user, and display a finally selected first target temperature and second target temperature; display a temperature of a current liquid; display a current stage which is the water heating stage or the constant temperature control stage; display selected constant temperature duration on the display panel 129 in real time depending on a constant temperature duration selection of the user, and display finally specified constant temperature duration; and display current remaining constant temperature duration in real time over time, and display a detected pH value in a scenario with the pH sensing component. For example, the display panel 129 in FIG. 7A displays “current temperature: 25° C. (indicating that a temperature of a current liquid is 25° C.); constant temperature control stage (indicating that a current moment is in the constant temperature control stage); remaining duration: 20 hours (indicating that the remaining constant temperature duration is 20 hours)”. FIG. 7A illustrates an example description for example 1. This present disclosure sets no limitation on an arrangement position, an arrangement shape, an implementation method, and the like of each function key in example 1.

FIG. 7B is an example diagram of function keys for example 4 according to an embodiment of this present disclosure. The example diagram only shows a partial front view of the first housing 1211. The example diagram includes a second selection function key 1223 and the display panel 129. A plurality of available fermentation modes may further be displayed, such as the green tea fermentation mode, the black tea fermentation mode, the white tea fermentation mode, and the oolong tea fermentation mode shown in FIG. 7B. Optionally, an on/off function key is further included. When the user selects the black tea fermentation mode by using the second selection function key 1223, the second selection function key may implement the implementation functions described in the foregoing example 4, and display a selected fermentation mode in real time on the display panel 129 depending on a fermentation mode selection of the user, and display a finally selected fermentation mode; display a temperature of a current liquid; display a current stage which is the water heating stage or the constant temperature control stage; and display current remaining constant temperature duration in real time over time, and display a detected pH value in a scenario with pH sensing component. For example, the display panel 129 in FIG. 7B displays “current temperature: 28° C. (indicating that a temperature of a current liquid is 28° C.); black tea fermentation mode: constant temperature control stage (indicating that a current moment is in the constant temperature control stage of the black tea fermentation mode); remaining duration: 45 hours (indicating that the remaining constant temperature duration is 45 hours)”. FIG. 7B illustrates an example description for example 4. This present disclosure sets no limitation on an arrangement position, an arrangement shape, an implementation method, and the like of each function key in example 4.

For an example description for another example, refer to the description in FIG. 7A or FIG. 7B. Details are not described herein again.

In the foregoing descriptions in FIG. 1A to FIG. 7B, other components are optionally included on a basis that the temperature control apparatus 1 includes the base housing 121, the controller 122, the heating component 123, the air supply component 124, and the temperature sensing component.

In still another possible implementation, other components are optionally included on a basis that “a temperature control apparatus 1 includes a base housing 121, a controller 122, a heating component 123, a pH sensing component, and a temperature sensing component”. A specific implementation thereof is as follows:

The controller 122 and the heating component 123 are disposed in an inner cavity of the base housing 121. The controller 122 is electrically connected to the heating component 123. The controller 122 is electrically connected to the pH sensing component. The controller 122 is electrically connected to the temperature sensing component. The controller 122 is configured to perform temperature control by controlling, based on a temperature detected by the temperature sensing component, the heating component 123 to start or stop working, so that a controlled temperature detected by the temperature sensing component is maintained in a first temperature interval. The controller 122 is configured to stop the temperature control if a pH value detected by the pH sensing component falls in a first pH value interval. The controller 122 is further configured to remind a user if the pH value detected by the pH sensing component falls in a second pH value interval.

Optionally, the temperature control apparatus 1 further includes a first communications interface. For implementation of a connection manner of the pH sensing component, refer to detailed descriptions in FIG. 1A to FIG. 7B. Details are not described herein again.

Optionally, in an aspect of the controlling, based on a temperature detected by the temperature sensing component, the heating component 123 to start or stop working, so that a controlled temperature detected by the temperature sensing component is maintained in a first temperature interval, the controller 122 is specifically configured to: in response to determining that a temperature detected by the temperature sensing component is lower than a lowest temperature of the first temperature interval, control the heating component 123 to start working, and in response to determining that the temperature detected by the temperature sensing component falls in the first temperature interval, control the heating component 123 to stop working.

Optionally, the temperature control apparatus 1 further includes an air supply component 124, and the controller 122 is electrically connected to the air supply component 124 and configured to: control, based on a temperature detected by the temperature sensing component, the air supply component 124 to start or stop working, so that a second controlled temperature detected by the temperature sensing component is maintained in a second temperature interval.

Optionally, the base housing 121 includes one or more air inlets, and further includes one or more air outlets. The one or more air outlets can be disposed on an upper surface of the base housing 121. The upper surface of the base housing 121 can be configured to place the kettle 11. The one or more air outlets can be partially covered by the kettle 11 or be not covered by the kettle 11 at all. The base housing 121 can be configured such that, when the air supply component 124 is working, an air flow comes in through the one or more air inlets and comes out through the one or more air outlets. For specific implementation, refer to the detailed descriptions in FIG. 1A to FIG. 7B. Details are not described herein again.

Optionally, in an aspect of the controlling, based on a temperature detected by the temperature sensing component, the air supply component 124 to start or stop working, so that a controlled temperature detected by the temperature sensing component is maintained in a second temperature interval, the controller 122 is specifically configured to: if the controller 122 determines that the temperature detected by the temperature sensing component is higher than a highest temperature of the second temperature interval, control the air supply component 124 to start working, and when the temperature detected by the temperature sensing component falls in the second temperature interval, control the air supply component 124 to stop working.

Optionally, the temperature control apparatus 1 further includes an air flow transfer housing 125. For specific implementation, refer to the detailed descriptions in FIG. 1A to FIG. 7B. Details are not described herein again.

Optionally, in an aspect of the controlling, based on a temperature detected by the temperature sensing component, the heating component 123 to start or stop working, so that a controlled temperature detected by the temperature sensing component is maintained in a first temperature interval, the controller 122 is specifically configured to: if the controller 122 determines that the temperature detected by the temperature sensing component is lower than the lowest temperature of the first temperature interval, control the heating component 123 and the air supply component 124 to start working, and when the temperature detected by the temperature sensing component falls in the first temperature interval, control the heating component 123 and the air supply component 124 to stop working.

Optionally, the first temperature interval is the same as the second temperature interval.

Optionally, the temperature control apparatus 1 further includes a wireless communications module. For specific implementation, refer to the detailed descriptions in FIG. 1A to FIG. 7B. Details are not described herein again.

Optionally, a part of the upper surface of the base housing 121 includes a heat conducting plate; and the heat conducting plate is in contact with the heating component 123, and is configured to conduct heat generated by the heating component 123; and the temperature sensing component is disposed in the inner cavity of the base housing 121 and touches the heat conducting plate to detect a conducted temperature. For specific implementation, refer to the detailed descriptions in FIG. 1A to FIG. 7B. Details are not described herein again.

Optionally, the temperature control apparatus 1 further includes the first communications interface, the temperature sensing component includes a temperature sensor, a communications data line, and a third communications interface, the third communications interface is connected to the temperature sensor by using the communications data line, the first communications interface is connected to the third communications interface so that the temperature sensing component is electrically connected to the controller 122, and the temperature sensing component is configured to detect a temperature of the liquid accommodated by the kettle 11 placed on the upper surface of the base housing 121. For specific implementation, refer to the detailed descriptions in FIG. 1A to FIG. 7B. Details are not described herein again.

Optionally, the temperature control apparatus 1 further includes the kettle 11. For specific implementation, refer to the detailed descriptions in FIG. 1A to FIG. 7B. Details are not described herein again.

In still another possible implementation, other components are optionally included on a basis that “the temperature control apparatus 1 includes a base housing 121, a controller 122, a heating component 123, and a temperature sensing component”. For a specific implementation process of each component in the latter two different implementations, refer to the descriptions in FIG. 1A to FIG. 7B. Details are not described herein again. The controller 122 and the heating component 123 are disposed in an inner cavity of the base housing 121; the controller 122 is electrically connected to the heating component 123; and the controller 122 is electrically connected to the temperature sensing component; the controller 122 is configured to: perform temperature control by controlling, based on a temperature detected by the temperature sensing component, the heating component 123 to start or stop working, so that a controlled temperature detected by the temperature sensing component is maintained in a first temperature interval; and the controller 122 is configured to stop temperature control if first constant temperature duration in which the controller 122 performs temperature control is not less than a preset constant temperature duration; where the preset constant temperature duration is determined based on at least one of: a constant temperature duration operation performed by a user on the temperature control apparatus 1, or constant temperature duration operation information sent by a target terminal, or a default constant temperature duration of the temperature control apparatus 1.

Optionally, in an aspect of the controlling the heating component 123 to start or stop working, so that a controlled temperature detected by the temperature sensing component is maintained in a first temperature interval, the controller 122 is specifically configured to: in response to determining that the temperature detected by the temperature sensing component is lower than a lowest temperature of the first temperature interval, control the heating component 123 to start working, and in response to determining the temperature detected by the temperature sensing component falls in the first temperature interval, control the heating component 123 to stop working.

Optionally, the temperature control apparatus 1 further includes an air supply component 124, and the controller 122 is electrically connected to the air supply component 124.

In an aspect of the performing temperature control, the controller 122 is further configured to: control, based on the temperature detected by the temperature sensing component, the air supply component 124 to start or stop working, so that a controlled temperature detected by the temperature sensing component is maintained in a second temperature interval.

Optionally, the base housing 121 includes one or more air inlets, and further includes one or more air outlets; the one or more air outlets are disposed on an upper surface of the base housing 121; the upper surface of the base housing 121 is configured to place a kettle 11; and the one or more air outlets are partially covered by the kettle 11 or are not covered by the kettle 11 at all; and when the air supply component 124 is working, an air flow comes in through the one or more air inlets and comes out through the one or more air outlets. For specific implementation, refer to the detailed descriptions in FIG. 1A to FIG. 7B. Details are not described herein again.

Optionally, in an aspect of the controlling, based on the temperature detected by the temperature sensing component, the air supply component 124 to start or stop working, so that a controlled temperature detected by the temperature sensing component is maintained in a second temperature interval, the controller 122 is specifically configured to: in response to determining that the temperature detected by the temperature sensing component is higher than a highest temperature of the second temperature interval, control the air supply component 124 to start working, and in response to determining the temperature detected by the temperature sensing component falls in the second temperature interval, control the air supply component 124 to stop working.

Optionally, the temperature control apparatus 1 further includes an air flow transfer housing 125. For specific implementation, refer to the detailed descriptions in FIG. 1A to FIG. 7B. Details are not described herein again.

Optionally, in an aspect of the controlling, based on a temperature detected by the temperature sensing component, the heating component 123 to start or stop working, so that a controlled temperature detected by the temperature sensing component is maintained in a first temperature interval, the controller 122 is specifically configured to: in response to determining that the temperature detected by the temperature sensing component is lower than the lowest temperature of the first temperature interval, control the heating component 123 and the air supply component 124 to start working, and in response to determining the temperature detected by the temperature sensing component falls in the first temperature interval, control the heating component 123 and the air supply component 124 to stop working.

Optionally, the first temperature interval is the same as the second temperature interval. In this case, the heating component 123 and the air supply component 124 are configured to implement constant temperature control.

Optionally, the temperature control apparatus 1 further includes a wireless communications module and a pH sensing component. For specific implementation, refer to the detailed descriptions in FIG. 1A to FIG. 7B. Details are not described herein again.

Optionally, the controller 122 is further configured to send at least one of the detected temperature, the detected pH value, the first constant temperature duration, and remaining constant temperature duration to the target terminal at a preset time interval by using the wireless communications module; where the remaining constant temperature duration is a difference obtained by subtracting the first constant temperature duration from the preset constant temperature duration; and the controller 122 is further configured to receive at least one of temperature interval operation information, pH value interval operation information, constant temperature duration operation information, and temperature control stop information by using the wireless communications module. For specific implementation, refer to the detailed descriptions in FIG. 1A to FIG. 7B. Details are not described herein again.

Optionally, the temperature control apparatus 1 further includes a first communications interface, the pH sensing component includes a pH sensor, a communications data line, and a second communications interface, the second communications interface is connected to the pH sensor by using the communications data line, the first communications interface is connected to the second communications interface so that the pH sensing component is electrically connected to the controller 122, and the pH sensor is configured to detect a pH value of a liquid accommodated by the kettle 11 placed on the upper surface of the base housing 121. For specific implementation, refer to the detailed descriptions in FIG. 1A to FIG. 7B. Details are not described herein again.

Optionally, a part of the upper surface of the base housing 121 includes a heat conducting plate; and the heat conducting plate is in contact with the heating component 123, and is configured to conduct heat generated by the heating component 123; and the temperature sensing component is disposed in the inner cavity of the base housing 121 and touches the heat conducting plate to detect a conducted temperature. For specific implementation, refer to the detailed descriptions in FIG. 1A to FIG. 7B. Details are not described herein again.

Optionally, the temperature control apparatus 1 further includes the first communications interface, the temperature sensing component includes a temperature sensor, a communications data line, and a third communications interface, the third communications interface is connected to the temperature sensor by using the communications data line, the first communications interface is connected to the third communications interface so that the temperature sensing component is electrically connected to the controller 122, and the temperature sensing component is configured to detect a temperature of the liquid accommodated by the kettle 11 placed on the upper surface of the base housing 121. For specific implementation, refer to the detailed descriptions in FIG. 1A to FIG. 7B. Details are not described herein again.

Optionally, the temperature control apparatus 1 further includes the kettle 11. For specific implementation, refer to the detailed descriptions in FIG. 1A to FIG. 7B. Details are not described herein again.

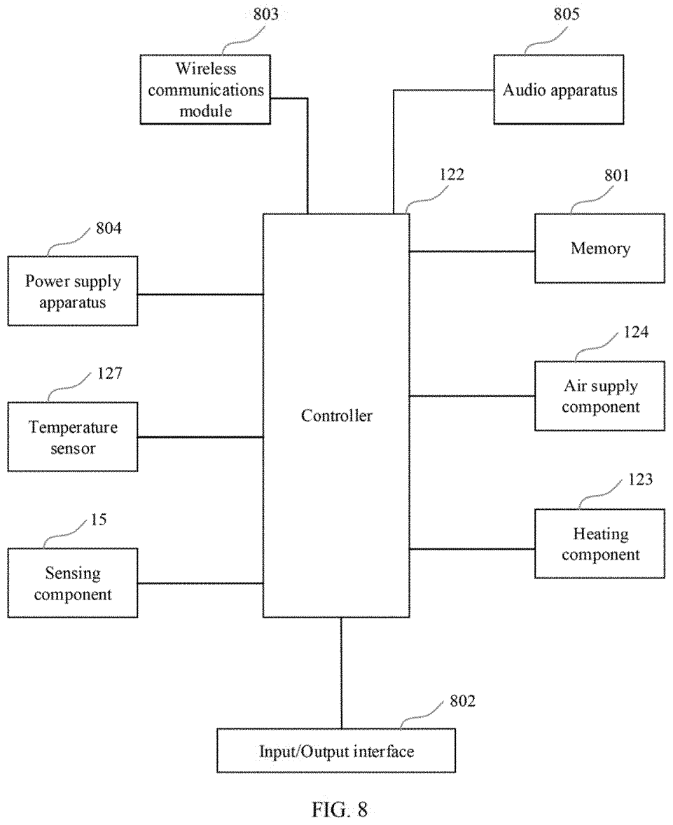

FIG. 8 is a schematic structural diagram of another temperature control apparatus according to an embodiment of this present disclosure. As shown in FIG. 8, the temperature control apparatus includes a controller 122, a heating component 123, an air supply component 124, and a temperature sensor 127. Optionally, the temperature control apparatus further includes one or more of a sensing component 15, a memory 801, an input/output interface 802, a wireless communications module 803, a power supply apparatus 804, and an audio apparatus 805. A person skilled in the art may understand that a hardware structure shown in FIG. 8 does not constitute a limitation on the temperature control apparatus. The temperature control apparatus may have more or fewer components than those shown in FIG. 8, or may combine two or more components, or may have different component configurations. Various components shown in FIG. 8 may be implemented in hardware that includes one or more signal processing circuits and/or application-specific integrated circuits, software, or a combination of hardware and software.

The foregoing components may communicate by using one or more communications lines (or buses).

The controller 122 is a control center of the temperature control apparatus, and is connected to components of the temperature control apparatus by using various interfaces and lines. The memory 801 may be configured to store an application program, data, and the like. Various functions and processing data of the temperature control apparatus are executed by running or executing a program instruction or program code stored in the memory 801 and by invoking data and instructions stored in the memory 801.

The heating component 123 is configured to start heating when the controller 122 controls the heating component 123 to start, and stop heating when the controller 122 controls the heating component 123 to stop.

The air supply component 124 is configured to start working when the controller 122 controls the air supply component 124 to start, and stop working when the controller 122 controls the air supply component 124 to stop.

The temperature sensor 127 may send a detected temperature to the controller 122, so that the controller 122 controls the temperature control apparatus based on the temperature.

The sensing component 15 may be electrically connected to the controller 122 by using a peripheral interface. For example, the sensing component 15 is the temperature sensing component 13, or the pH sensing component, or the peripheral component 14 in the foregoing embodiments. It may be understood that, when the controller 122 establishes a connection to each of the temperature sensor 127 and the sensing component 15, the temperature control apparatus may be controlled based on the descriptions in the foregoing embodiments.

The input/output interface 802 may provide signal input for a user, display information to the user, and the like. The input/output interface 802 may include at least one of a control function key or a selection function key. As described in the foregoing embodiments, the user inputs a signal by using a function key. The input/output interface 802 further includes a display panel 129, so as to display information such as a temperature of a current liquid and a current stage to the user. The display panel in any one of the embodiments of this present disclosure may be a liquid crystal display (LCD) or may be an organic light-emitting diode (OLED). Optionally, the display panel 129 may be a touchscreen, and may implement input and output functions of the temperature control apparatus by using the touchscreen.

The wireless communications module 803 may implement communication between the temperature control apparatus and a target terminal, for example, send a notification message or a reminder message to the target terminal. In a feasible solution, the wireless communications module 803 is a Bluetooth module, and the temperature control apparatus may directly communicate with the target terminal. Alternatively, in another feasible solution, the wireless communications module 803 is a Wi-Fi module, and the temperature control apparatus may communicate with the target terminal by using a server, may further help the user provide wireless broadband Internet access, and may further send temperature control apparatus information of the temperature control apparatus, user information of the temperature control apparatus, or the like to the server. The user may send a control message or an operation message to the server by using the target terminal to control the temperature control apparatus.

The power supply apparatus 804 supplies power to the temperature control apparatus. The controller 122 may manage functions such as charging and discharging by using the power supply apparatus 804.

The audio apparatus 805 may send a notification such as a voice message to a user, for example, the audio apparatus 805 receives a notification signal of the controller 122, and outputs the notification signal.

Both the foregoing embodiments and an embodiment shown in FIG. 9 may be implemented in the temperature control apparatus having the structure shown in FIG. 8.

In the embodiments shown in FIG. 1A to FIG. 8, the temperature control apparatus may implement temperature control, for example, may implement a heating function and a constant temperature control function. For example, in a fermented tea preparation scenario, the temperature control apparatus may control a temperature of a liquid to which a ferment substance is added, so that the temperature of the liquid is maintained in a constant temperature interval. In this way, a fermentation time is shortened through constant temperature control, and fermented tea preparation efficiency and a fermented tea preparation success rate are improved. In addition, a user does not need to pour the liquid from one container to another, and operations are simple and facilitate use by the user.

The following describes a fermented tea manufacturing method in this present disclosure. FIG. 9 is a schematic flowchart of a fermented tea manufacturing method according to an embodiment of this present disclosure. As shown in FIG. 9, the method can include steps 901 to 904:

901. a first stage: heating water accommodated in a kettle, and stopping heating when a temperature of the water falls in a first temperature interval;

902. a second stage: adding tea leaves into the kettle at a first moment, taking out the tea leaves after a first time period following the adding, and adding sugar into the kettle at a second moment to form a first liquid;

903. a third stage: when a cooled temperature of the first liquid falls in a second temperature interval, adding a ferment substance including enzymes to the first liquid to form a second liquid; and

904. a fourth stage: controlling a temperature of the second liquid, so that the temperature of the second liquid is maintained in the second temperature interval for 3 to 21 days, to obtain fermented tea.

Before the foregoing four steps are performed, the method can further include a process in which a user operates a temperature control apparatus, which may be specifically performed in any one of the following operation manners:

Operation manner 1: When the temperature control apparatus includes a water heating function key, a constant temperature control function key, and a first selection function key, the user may enable the water heating function key after powering on the temperature control apparatus, and select a first target temperature within a first preset time period by using the first selection function key. Then, the user may enable the constant temperature control function key, and select a second target temperature within a second preset time period by using the first selection function key. It should be noted that the operation of enabling the water heating function key is performed before step 901, and the operation of enabling the constant temperature control function key is performed before step 903. This present disclosure sets no limitation on a specific moment at which each operation is performed.

Operation manner 2: When the temperature control apparatus includes a water heating function key and a first selection function key, the user may enable the water heating function key after powering on the temperature control apparatus, and select a first target temperature within a first preset time period by using the first selection function key. It should be noted that the operation of enabling the water heating function key is performed before step 901. This present disclosure sets no limitation on a specific moment at which each operation is performed.

Operation manner 3: When the temperature control apparatus includes a constant temperature control function key and a first selection function key, the user may enable the constant temperature control function key after powering on the temperature control apparatus, and select a second target temperature within a second preset time period by using the first selection function key. It should be noted that the operation of enabling the constant temperature control function key is performed before step 901.

Operation manner 4: When the temperature control apparatus includes a second selection function key, the user may select a target fermentation mode by using the second selection function key after powering on the temperature control apparatus. It should be noted that the operation of selecting the target fermentation mode is performed before step 901.

In the foregoing operation manner 1, operation manner 2, operation manner 3, or operation manner 4, optionally, when the temperature control apparatus further includes an on/off function key, after inserting a plug into a socket, the user further needs to perform an operation of enabling the on/off function key, so as to power on the temperature control apparatus.

In the foregoing operation manner 1, operation manner 2, operation manner 3, or operation manner 4, optionally, when the temperature control apparatus further includes a constant temperature duration function key, the user may further enable the constant temperature duration function key, and select constant temperature duration by using the first selection function key or the second selection function key within a third preset time period. It should be noted that the operation of enabling the constant temperature duration function key is performed before step 903. This present disclosure sets no limitation on a specific moment at which each operation is performed.

In the foregoing operation manner 1, operation manner 2, operation manner 3, or operation manner 4, optionally, if no temperature sensing component is connected, it indicates that fermented tea is prepared in a normal mode. To prepare fermented tea in a precise mode, a communication connection may be established between a temperature sensing component and the temperature control apparatus before step 903. This present disclosure sets no limitation on a specific moment at which an operation of connecting the temperature sensing component is performed.

Further, before powering on the temperature control apparatus, the user may first add water to the kettle of the temperature control apparatus, and then perform any one of the foregoing operation manner 1, operation manner 2, operation manner 3, or operation manner 4, so that the user can directly operate the temperature control apparatus. Alternatively, after adding water to the kettle of the temperature control apparatus, the user may further send remote operation information by using a target terminal, where the remote operation information may be information corresponding to the foregoing operation manner 1, operation manner 2, operation manner 3, or operation manner 4. Actually, the user implements an operation on the temperature control apparatus by using an operation on the target terminal. Specifically, the user sends the remote operation information on the target terminal to the temperature control apparatus, and the temperature control apparatus performs temperature control based on the remote operation information. For example, the remote operation information may include at least one of the following: a selection of a water heating function, a selection of a constant temperature control function, a selection of the first target temperature (or a selection of the first temperature interval), a selection of the second target temperature (or the selection of the second temperature interval), a selection of a first pH value interval, a selection of a second pH value interval, and a selection of preset constant temperature duration. The example remote operation information herein may be sent to the temperature control apparatus at different time, and this embodiment of this present disclosure sets no limitation thereto.

After receiving the operation of the user, the temperature control apparatus first performs step 901 to heat the water accommodated in the kettle, and stops heating when a temperature of the water falls in the first temperature interval. This embodiment of this present disclosure sets no limitation on heating duration at the first stage because the heating duration is related to an amount of water, power of a heating component, an initial temperature of the water, an environment, and the like.

Optionally, when the temperature of the water reaches the first temperature interval, a first notification message is sent to remind the user to add sugar and tea leaves, for example, in a voice broadcast manner, or the first notification message is sent to the target terminal, where the target terminal is a terminal bound to the temperature control apparatus.

Then, step 902 is performed by adding the tea leaves into the kettle at the first moment, taking out the tea leaves after the first time period following the addition, and adding sugar into the kettle at the second moment to form the first liquid.

In this embodiment of this present disclosure, the first moment and the second moment may be a same moment, or may be different moments. This embodiment of this present disclosure sets no limitation on specific values of the first moment and the second moment. For example, it is assumed that the second moment is later than the first moment. The tea leaves are added at the first moment, and after the tea leaves are soaked in the heated water for the first time period, the tea leaves are taken out. After the tea leaves are removed, sugar is added, so that the sugar dissolves in the tea. Compared with a solution in which the second moment is not later than the first moment, in this embodiment of this present disclosure, it can be avoided that some sugar is taken out together with the tea leaves. Optionally, dissolution of the sugar may be accelerated by proper stirring. The first time period herein may be 5 to 20 minutes or 5 to 10 minutes, and this present disclosure sets no limitation on the first time period.

Optionally, the temperature control apparatus may cool the first liquid after stopping the heating, and may stop the cooling when a temperature of the first liquid falls in the second temperature interval. Specifically, the temperature control apparatus counts time starting from a moment at which the temperature control apparatus stops the heating at the first stage, and after the counted time reaches the second time period, the temperature control apparatus cools the first liquid by using an air supply component, and stops the cooling when the temperature of the first liquid falls in the second temperature interval. In this way, cooling of the first liquid can be accelerated. The second time period is preset, and may be any duration from 5 to 10 minutes. Optionally, tea leaves and sugar may further be added in the second time period. In this way, time for executing the second stage is reserved for the user, a cooling function is automatically started, and an operation of the user is simplified.

Further, optionally, when the temperature of the first liquid reaches the second temperature interval, the temperature control apparatus sends a second notification message that is used to remind the user to add the ferment substance including enzymes, for example, in the voice broadcast manner, or sends the second notification message to the target terminal, or sends the second notification message to the target terminal by using a server. The target terminal is a terminal bound to the temperature control apparatus.

Subsequently, step 903 is performed by adding the ferment substance including enzymes to the first liquid when the cooled temperature of the first liquid falls in the second temperature interval, so as to form the second liquid. For example, the ferment substance may be SCOBY (scoby) (or referred to as a starter culture), or the ferment substance may be starter tea (or referred to as a fungus liquid), or the ferment substance may be a mixture of SCOBY and starter tea (or a mixture of a starter culture and a fungus liquid). The starter tea herein is previously prepared fermented tea. In an optional solution, if the tea leaves at the second stage are green tea leaves, the starter tea herein is previously prepared fermented green tea. This is merely an example for description. This present disclosure sets no limitation on the starter tea added in a fermented tea preparation process. In addition, the enzymes in this present disclosure may be tea enzymes, tea fungus, black tea fungus, or the like. This embodiment of this present disclosure sets no limitation on the enzymes that can be used to prepare fermented tea.

In this embodiment of this present disclosure, it may be determined, based on a pH value of the second liquid obtained after the ferment substance is added, whether an amount of the added ferment substance is relatively small. If the amount of the added ferment substance is relatively small, fermented tea fails to be prepared or a fermented tea preparation time is prolonged. This embodiment of this present disclosure includes the following two possible implementations for detecting a first pH value:

In a possible implementation, after adding the ferment substance, the user may manually detect a first pH value of the second liquid, for example, detect the first pH value of the second liquid by using pH test paper. A specific solution is to use the pH test paper to test the second liquid in a third time period in which the ferment substance is added for the first time, and the user can determine a pH value of the second liquid as the first pH value, e.g., by comparing with a threshold pH value. For example, if the pH value of the second liquid is not greater than 4.5, the method step 904 at the fourth stage is performed and the pH value of the second liquid is set as the first pH value; if the first pH value of the second liquid is greater than 4.5, the user may need to continue to add the ferment substance, and may detect the pH value of the second liquid again after adding the ferment substance. The third time period may be any duration from 0 to 2 hours. A small amount of the ferment substance may be added for a plurality of times in a process of continuing ferment substance addition, so as to avoid adding an excessive amount of the ferment substance at a time.

In another possible implementation, the user may connect a pH sensing component or a peripheral component to the temperature control apparatus, so as to detect the first pH value of the second liquid by using the pH sensing component or the peripheral component. The pH sensing component or the peripheral component may be connected after the ferment substance is added, or may be connected after the second liquid is formed. For specific implementation, refer to the following descriptions (1) to (4):

(1) In a process in which the pH sensing component or the peripheral component is successfully connected to the temperature control apparatus, the pH sensing component or the peripheral component may detect a pH value of a current liquid at a preset time interval, and send the pH value to the controller 122. A pH value of the first liquid is greater than or equal to 6 after the sugar and tea leaves are added at the second stage. Therefore, at the third stage, the pH value of the current liquid changes abruptly once the ferment substance is added.

First, the controller 122 may receive the pH value sent by the pH sensing component or the peripheral component. When the controller 122 determines that a temperature of the current liquid falls in the second temperature interval, if the controller 122 detects an abrupt change of the pH value, the controller determines whether the abruptly changed pH value is greater than 4.5. The abrupt change of the pH value is used to indicate that an absolute value of a difference between a pH value at a third moment and a pH value at a fourth moment is greater than a threshold (for example, the threshold is 1). The abruptly changed pH value is represented by the first pH value, the first pH value is a pH value that meets a first condition after the abrupt change of the pH value, and the first condition is that a difference between a pH value adjacent to the first pH value and the first pH value is about 0.2. The third moment and the fourth moment are two moments between which a time interval does not exceed 5 to 15 minutes when the temperature of the current liquid falls in the second temperature interval.

Next, if the controller determines that the first pH value of the second liquid is not greater than 4.5, the method step at the fourth stage is performed. If the controller determines that the first pH value of the second liquid is greater than 4.5, the controller displays, on a display panel 129 of the temperature control apparatus, a notification for continuing to add the ferment substance, or outputs, by using a voice broadcast function of the temperature control apparatus, the notification for continuing to add the ferment substance, or sends, to the target terminal bound to the temperature control apparatus, the notification message for continuing to add the ferment substance; and the controller continues to perform determining on a pH value sent by the pH sensing component or the peripheral component. A small amount of the ferment substance may be added for a plurality of times in a process of continuing ferment substance addition, so as to avoid adding an excessive amount of the ferment substance at a time.

(2) In a process in which the pH sensing component or the peripheral component is successfully connected to the temperature control apparatus, the pH sensing component or the peripheral component may send a currently detected pH value of the liquid to the controller after receiving a pH value obtaining request sent by the controller 122. Specific implementation is as follows:

First, when the controller 122 determines that the temperature of the current liquid falls back to the second temperature interval for the first time after the first stage, the controller 122 sends the pH value obtaining request to the pH sensing component or the peripheral component. After receiving the pH value obtaining request, the pH sensing component or the peripheral component detects the first pH value of the current liquid, and sends the first pH value to the controller 122.

Next, the controller 122 receives the first pH value of the current liquid detected by the pH sensing component or the peripheral component.

Finally, if the controller determines that the first pH value of the second liquid is not greater than 4.5, the method step at the fourth stage is performed. If the controller determines that the first pH value of the second liquid is greater than 4.5, the controller displays, on the display panel 129 of the temperature control apparatus, the notification for continuing to add the ferment substance, or outputs, by using the voice broadcast function of the temperature control apparatus, the notification for continuing to add the ferment substance, or sends, to the target terminal bound to the temperature control apparatus, the notification message for continuing to add the ferment substance; and in a time range from 5 to 30 minutes following a moment at which a previous pH value obtaining request is sent, the controller sends the pH value obtaining request again and performs determining based on received response information.

(3) In a process in which the pH sensing component or the peripheral component is successfully connected to the temperature control apparatus, the pH sensing component or the peripheral component may detect the first pH value of the current liquid at a preset time interval, and send the first pH value to the controller 122, so that the controller 122 sends the received first pH value to the target terminal bound to the temperature control apparatus.

(4) In a process in which the pH sensing component or the peripheral component is successfully connected to the temperature control apparatus, the pH sensing component or the peripheral component may detect the first pH value of the current liquid at a preset time interval, and send the first pH value to the controller 122, so that the controller 122 displays the received first pH value on the display panel 129 in real time.

The foregoing solutions (3) and (4) enable the user to view the first pH value of the current liquid in real time, and determine, based on the real-time first pH value, whether to continue ferment substance addition. For example, if the first pH value of the second liquid is not greater than 4.5, the method step at the fourth stage may be performed. If the first pH value of the second liquid is greater than 4.5, the user needs to continue to add the ferment substance and may view a real-time pH value again after adding the ferment substance. A small amount of the ferment substance may be added for a plurality of times in a process of continuing ferment substance addition, so as to avoid adding an excessive amount of the ferment substance at a time.

Then, step 904 is performed by controlling a temperature of the second liquid, so that the temperature of the second liquid is maintained in the second temperature interval for 3 to 21 days, to obtain fermented tea.

In step 904, a specific implementation process of controlling the temperature of the second liquid is as follows: If the temperature of the second liquid is higher than a highest temperature of the second temperature interval, the temperature control apparatus cools the second liquid by using the air supply component and stops cooling when the temperature of the second liquid falls in the second temperature interval. If the temperature of the second liquid is lower than a lowest temperature of the second temperature interval, the temperature control apparatus heats the second liquid by using a heating component 123, and stops heating when the temperature of the second liquid falls in the second temperature interval. When the temperature of the second liquid is lower than the lowest temperature of the second temperature interval, the temperature control apparatus may further heat the second liquid by using the heating component 123, and transfer an air flow generated through heating to the kettle by using the air supply component, and stop heating when the temperature of the second liquid falls in the second temperature interval. In this way, when the current temperature of the liquid is lower than a constant temperature interval, the temperature control apparatus can evenly heat the liquid, thereby ensuring a better temperature environment for fermented tea preparation, and improving fermented tea preparation efficiency and a fermented tea preparation success rate.

Optionally, a temperature of the second liquid needs to be maintained in the second temperature interval for a specific duration so as to prepare fermented tea. In this embodiment of this present disclosure, the specific duration is represented by the preset constant temperature duration. When first constant temperature duration in which constant temperature control is performed is not less than (identical to or more than) the preset constant temperature duration, it indicates that fermented tea preparation is completed. The preset constant temperature duration may be counted starting from a moment when the cooled temperature of the first liquid falls in the second temperature interval at the third stage. The preset constant temperature duration is determined based on a constant temperature duration operation performed by the user on the temperature control apparatus, or is determined based on constant temperature duration operation information sent by the target terminal, or is default constant temperature duration of the temperature control apparatus. The constant temperature duration in this present disclosure is any time period from 3 to 21 days. Actually, after the temperature is maintained in the second temperature interval for 7 to 10 days, the fermented tea features a moderate sour and sweet flavor, and is more in line with the public taste.

Optionally, the temperature control apparatus may determine a fermentation degree of the fermented tea based on a second pH value of the second liquid at the fourth stage. This embodiment of this present disclosure includes the following two possible implementations for determining the second pH value:

In a possible implementation, when a temperature of the second liquid has been maintained in the second temperature interval for at least 3 days, the user may manually detect the second pH value of the second liquid, for example, detect the second pH value of the second liquid by using pH test paper. A specific solution is to test the second liquid by using the pH test paper, so that the user determines, through comparison or another method, a pH value of the second liquid as the second pH value. If the second pH value is greater than 2 and less than 4, it is determined that the second liquid at a current moment is already fermented tea, and the user may choose to control the temperature control apparatus to stop working (that is, stop fermentation). For example, when the second pH value of the second liquid is greater than 2.5 and less than 3.5, the second liquid features a moderate sour and sweet flavor. If the user prefers a sour flavor, the user may choose to continue fermentation. If the user prefers a sweet flavor, the user may be reminded to perform the test and determine the pH value earlier so as to stop the temperature control apparatus earlier. If the second pH value is not less than 4, fermentation continues. If the second pH value is less than 2, the temperature control apparatus needs to be stopped, because a taste of current fermented tea is already quite sour, and some beneficial species may not survive in an environment with a pH value less than 2. Therefore, it needs to be ensured as much as possible that the pH value of the fermented tea is greater than 2, so that survival of more beneficial species in the fermented tea can be ensured.

In another possible implementation, the user may connect the pH sensing component or the peripheral component before the fourth stage, so as to detect the second pH value of the second liquid by using the pH sensing component or the peripheral component. Note that, to distinguish a pH value in this implementation from the pH value detected at the third stage, the pH value in this implementation is represented by the second pH value. For specific implementation, refer to the following descriptions in (1) to (4):

(1) In a process in which the pH sensing component or the peripheral component is successfully connected to the temperature control apparatus, the pH sensing component or the peripheral component may detect the second pH value of the current liquid at a preset time interval, and send the pH value to the controller 122. When a current moment exists at the fourth stage and a temperature of the second liquid has been maintained in the second temperature interval for at least 3 days, if the second pH value of the second liquid is not less than 4, the controller may continue to perform the method step at the fourth stage; or if the second pH value of the second liquid is greater than 2 and less than 4, the controller 122 determines that the second liquid at the current moment is already fermented tea, and may choose to control the temperature control apparatus to stop working (that is, stop fermentation), or may choose to continue fermentation; or if the second pH value is less than 2, the controller stops the temperature control apparatus, because a taste of the current fermented tea is already quite sour, and some beneficial species may not survive in an environment with a pH value less than 2. Therefore, it needs to be ensured as much as possible that the pH value of the fermented tea is greater than 2, so that survival of more beneficial species in the fermented tea can be ensured.

(2) In a process in which the pH sensing component or the peripheral component is successfully connected to the temperature control apparatus, the pH sensing component or the peripheral component may send a currently detected pH value of the liquid to the controller after receiving a pH value obtaining request sent by the controller 122. Specific implementation is as follows: When a current moment exists at the fourth stage and a temperature of the second liquid has been maintained in the second temperature interval for at least 3 days, the controller 122 sends a pH value acquiring request to the pH sensing component or the peripheral component. After receiving the pH value obtaining request, the pH sensing component or the peripheral component detects the second pH value of the current liquid, and sends the second pH value to the controller 122. If the second pH value of the second liquid is not less than 4, the controller may continue to perform the method step at the fourth stage; or if the second pH value of the second liquid is greater than 2 and less than 4, the controller 122 determines that the second liquid at the current moment is already fermented tea, and may choose to control the temperature control apparatus to stop working (that is, stop fermentation), or may choose to continue fermentation; or if the second pH value is less than 2, the controller 122 stops the temperature control apparatus, because a taste of the current fermented tea is already quite sour, and some beneficial species may not survive in an environment with a pH value less than 2. Therefore, it needs to be ensured as much as possible that the pH value of the fermented tea is greater than 2, so that survival of more beneficial species in the fermented tea can be ensured.

For the foregoing solutions (1) and (2), the controller 122 needs to control the second liquid at the fourth stage to implement constant temperature control. Therefore, the controller 122 may determine whether the fourth stage is ongoing; or in other words, the controller 122 may determine whether a constant temperature control stage is ongoing. In addition, the temperature control apparatus is provided with a timer. In the fermented tea preparation process, the controller may perform constant temperature control based on the default constant temperature duration or constant temperature duration specified by the user, so that the controller 122 may determine duration in which the temperature of the second liquid is maintained in the second temperature interval. In conclusion, the controller 122 may determine whether the current moment exists at the fourth stage and determine a quantity of days for which the temperature of the second liquid is maintained in the second temperature interval.

(3) In a process in which the pH sensing component or the peripheral component is successfully connected to the temperature control apparatus, the pH sensing component or the peripheral component may detect the second pH value of the current liquid at a preset time interval, and send the second pH value to the controller 122, so that the controller 122 sends the received second pH value to the target terminal bound to the temperature control apparatus.

(4) In a process in which the pH sensing component or the peripheral component is successfully connected to the temperature control apparatus, the pH sensing component or the peripheral component may detect the second pH value of the current liquid at a preset time interval, and send the second pH value to the controller 122, so that the controller 122 displays the received second pH value on the display panel 129 in real time.

The foregoing solutions (3) and (4) enable the user to view the second pH value of the current liquid in real time, and determine, based on the real-time second pH value, whether to continue fermentation. For example, if the second pH value of the second liquid is not less than 4, the method step at the fourth stage may be performed. If the second pH value of the second liquid is greater than 2 and less than 4, the user may clarify that the second liquid is fermented tea with fermentation completed. If the second pH value of the second liquid is greater than 2.5 and less than 3.5, the second liquid features a proper sour and sweet flavor, and the user needs to determine, based on a personal flavor preference, whether to continue fermentation.

Optionally, a third notification message that is used to remind the user of fermentation completion is sent when fermented tea preparation is completed, for example, in the voice broadcast manner; or the third notification message is sent to the target terminal, where the target terminal is a terminal bound to the temperature control apparatus.

It should be noted that with reference to the foregoing embodiments, in addition to being manually controlled to stop working, the temperature control apparatus may further automatically determine fermented tea preparation completion (indicating that fermented tea can be obtained) based on the following feasible solutions, or in other words, may automatically determine, based on the following feasible solutions, when to stop working:

(1) When the temperature control apparatus is not connected to the pH sensing component, the controller determines whether fermented tea preparation is completed based on whether the first constant temperature duration in which constant temperature control is performed meets the preset constant temperature duration. Specifically, if actual constant temperature duration is equal to or greater than the preset constant temperature duration, the controller determines that fermented tea preparation is completed. If the actual constant temperature duration is less than the preset constant temperature duration, the controller determines that fermented tea preparation is not completed. The preset constant temperature duration in the feasible solution (1) may be any duration from 3 to 21 days by default, or may be constant temperature duration manually specified by the user.

(2) When the temperature control apparatus is connected to the pH sensing component, the controller determines fermented tea preparation completion based on the second pH value of the second liquid and based on whether actual constant temperature duration meets the preset constant temperature duration. Details are as follows:

If the pH value detected by the pH sensing component falls in the first pH value interval and the first constant temperature duration in which temperature control is performed is not less than the preset constant temperature duration, the controller tops temperature control.

If the pH value detected by the pH sensing component does not fall in the first pH value interval and the first constant temperature duration in which temperature control is performed is not less than the preset constant temperature duration, the controller sends a reminder message by using the wireless communications module, where the reminder message is used to notify that temperature control is stoppable.

If the pH value detected by the pH sensing component falls in the first pH value interval and the first constant temperature duration in which temperature control is performed is less than the preset constant temperature duration, the controller sends a reminder message by using the wireless communications module.

If the pH value detected by the pH sensing component does not fall in the first pH value interval, and the first constant temperature duration in which temperature control is performed is less than the preset constant temperature duration, the controller continues to perform temperature control. This indicates that the controller may continue to perform the method step at the fourth stage.

The reminder message herein may be used to notify that the user may choose to stop or continue temperature control. After sending the reminder message and before receiving feedback from the user, the controller continues to perform temperature control. If the controller receives a feedback message indicating that the user chooses to stop temperature control, the controller stops temperature control.

For example, the first pH value interval is [2, 2.5], and this embodiment of this present disclosure sets no limitation thereto.

(3) When there is no preset constant temperature duration, the controller determines fermented tea preparation completion based on the second pH value of the second liquid. Details are as follows:

If the pH value detected by the pH sensing component falls in the first pH value interval, the controller stops temperature control; or if the pH value detected by the pH sensing component falls in the second pH value interval, the controller reminds the user. The first pH value interval and the second pH value interval are different. For example, the first pH value interval is [2, 2.5], and the second pH value interval is [3.5, 4.5) and [2.5, 3.5). In this way, if the pH value detected by the pH sensing component falls in [3.5, 4.5), the controller 122 may remind the user that the user may choose to continue fermentation. After sending a reminder and before receiving feedback from the user, the controller 122 continues to perform temperature control. If the controller 122 receives a feedback message indicating that the user chooses to stop temperature control, the controller 122 stops temperature control. If the pH value detected by the pH sensing component falls in [2.5, 3.5), the controller 122 may remind the user that the user may chooses to stop fermentation. If the pH value detected by the pH sensing component falls in [2, 2.5], the controller 122 stops temperature control, that is, stops fermentation.

Further, the following describes tea leaf types, amount proportions of various additives, the first temperature interval, the second temperature interval, and the like in the embodiment shown in FIG. 9.

1. Description of the tea leaf types, the first temperature interval, and the second temperature interval

With reference to the foregoing operation manner 1, if the user does not select the first target temperature, the temperature control apparatus determines that the first temperature interval at the first stage is a first default temperature interval, where the first default temperature interval is [70° C., 100° C.]. If the user selects the first target temperature, the temperature control apparatus determines the first temperature interval with reference to a first preset temperature amplitude. For example, if the first preset temperature amplitude is 1° C. and the first target temperature is 90° C., the first temperature interval is [89° C., 91° C.]. The first preset temperature amplitude in this present disclosure may be 1° C. or 2° C., and the first target temperature in the fermented tea preparation process may be any temperature from 70° C. to 100° C. A manner of determining the first temperature interval is applicable to various types of tea leaves.

With reference to the foregoing operation manner 1, if the user does not select the second target temperature, the temperature control apparatus determines that the second temperature interval at the third stage is a second default temperature interval, where the second default temperature interval is [20° C., 32° C.]. If the user selects the second target temperature, the temperature control apparatus determines the second temperature interval with reference to a second preset temperature amplitude. For example, if the second preset temperature amplitude is 1° C. and the second target temperature is 30° C., the second temperature interval is [29° C., 31° C.]. The second preset temperature amplitude in this present disclosure may be 1° C. or 2° C., and the second target temperature in the fermented tea preparation process may be any temperature from 20° C. to 32° C. A manner of determining the second temperature interval is applicable to various types of tea leaves.

With reference to the foregoing operation manner 2, if the user does not select the first target temperature, the temperature control apparatus determines that the first temperature interval at the first stage is a first default temperature interval, where the first default temperature interval is [70° C., 100° C.]. If the user selects the first target temperature, the temperature control apparatus determines the first temperature interval with reference to a first preset temperature amplitude. For example, if the first preset temperature amplitude is 1° C. and the first target temperature is 90° C., the first temperature interval is [89° C., 91° C.]. The first preset temperature amplitude in this present disclosure may be 1° C. or 2° C., and the first target temperature in the fermented tea preparation process may be any temperature from 70° C. to 100° C. In the operation manner 2, the temperature control apparatus determines that the second temperature interval is a second default temperature interval, where the second default temperature interval is [20° C., 32° C.]. A manner of determining the first temperature interval and the second temperature interval is applicable to various types of tea leaves.

With reference to the foregoing operation manner 3, the temperature control apparatus determines that the first temperature interval is a first default temperature interval, where the first default temperature interval is [70° C., 100° C.]. If the user does not select the second target temperature, the temperature control apparatus determines that the second temperature interval at the third stage is a second default temperature interval, where the second default temperature interval is [20° C., 32° C.]. If the user selects the second target temperature, the temperature control apparatus determines the second temperature interval with reference to a second preset temperature amplitude. For example, if the second preset temperature amplitude is 1° C. and the second target temperature is 30° C., the second temperature interval is [29° C., 31° C.]. The second preset temperature amplitude in this present disclosure may be 1° C. or 2° C., and the second target temperature in the fermented tea preparation process may be any temperature from 20° C. to 32° C. A manner of determining the first temperature interval and the second temperature interval is applicable to various types of tea leaves.

With reference to the foregoing operation manner 4, the first temperature interval and the second temperature interval are corresponding to a fermentation mode. The fermentation mode herein is corresponding to a type of tea leaf. Specifically, the plurality of fermentation modes may include at least one of the following modes: a green tea fermentation mode, a black tea fermentation mode, a white tea fermentation mode, and an oolong tea fermentation mode. For example, Table 1 lists first temperature intervals and second temperature intervals corresponding to the fermentation modes.

TABLE 1

| | First temperature | Second temperature |
|---|---|---|
| Fermentation mode | interval | interval |
| Green tea | [79° C., 85° C.] | [20° C., 32° C.] |
| fermentation mode | | |
| Black tea | [94° C., 100° C.] | [20° C., 32° C.] |
| fermentation mode | | |
| White tea | [77° C., 83° C.] | [20° C., 32° C.] |
| fermentation mode | | |
| Oolong tea | [87° C., 93° C.] | [20° C., 32° C.] |
| fermentation mode | | |

In Table 1, default constant temperature duration corresponding to each fermentation mode may further be preset, and after the target fermentation mode is selected, constant temperature control is performed based on the default constant temperature duration corresponding to the target fermentation mode. The default constant temperature duration corresponding to each fermentation mode may be different, and this embodiment of this present disclosure sets no limitation thereto. Therefore, according to the operation manners, fermented tea can be prepared through one-click selection, which reduces a user operation and enhances user stickiness.

Optionally, in this embodiment of this present disclosure, the tea leaves may be added at the second stage in a tea bag manner, which facilitates separation of the tea leaves from the first liquid.

The value of each temperature or each temperature interval described above is used as an example for description. This embodiment of this present disclosure sets no limitation on a specific value of each temperature or temperature interval.

2. Description of an Amount of Each Additive

For every 1 L of water at the first stage, a weight of the sugar added at the second stage is 50 g to 80 g, a weight of the tea leaves added at the second stage is 4 g to 8 g, and a weight of the ferment substance added at the third stage is 50 to 200 g. For example, if the ferment substance is SCOBY (scoby) (or referred to as a starter culture), a weight of the ferment substance may be 50 g to 100 g; or if the ferment substance is starter tea (or referred to as a fungus liquid), a weight of the ferment substance may be 100 g to 200 g; or if the ferment substance is a mixture of SCOBY and starter tea (or a mixture of a starter culture and a fungus liquid), a weight of the ferment substance may be 80 g to 150 g. This present disclosure sets no limitation on a weight and a type of the sugar, a weight of the tea leaves, or a weight of the ferment substance added to every 1 L of water, and the user may change the weights for the addition based on a personal flavor preference.

The temperature control apparatus that implements the fermented tea manufacturing method in the embodiment shown in FIG. 9 may be the temperature control apparatus shown in FIG. 1 to FIG. 8, or may be another preparation device that can implement the method. This embodiment of this present disclosure sets no limitation thereto.

In the embodiment shown in FIG. 9, in the fermented tea preparation process, the temperature of the liquid to which the ferment substance is added may be controlled, so that the temperature of the liquid is maintained in a constant temperature interval. In this way, a fermentation time is shortened through constant temperature control, and fermented tea preparation efficiency and a fermented tea preparation success rate are improved. In addition, the user does not need to pour the liquid from one container to another, and operations are simple and facilitate use by the user.

The foregoing descriptions are merely example embodiments of the present disclosure, but are not intended to limit the present disclosure. Any modification, equivalent replacement, or improvement made without departing from the spirit and principle of the present disclosure should fall within the protection scope of the present disclosure.

1. A temperature control apparatus comprising: a base housing, a controller, a heating component, an air supply component, and a temperature sensing component, wherein the controller, the heating component, and the air supply component are disposed in an inner cavity of the base housing;
wherein the controller is electrically connected to the heating component, the air supply component, and the temperature sensing component, and
wherein the controller is configured to perform temperature control by:
controlling, based on a first temperature detected by the temperature sensing component, the heating component to start or stop working, so that a first controlled temperature detected by the temperature sensing component is maintained in a first temperature interval, and
controlling, based on a second temperature detected by the temperature sensing component, the air supply component to start or stop working, so that a second controlled temperature detected by the temperature sensing component is maintained in a second temperature interval.

2. The temperature control apparatus of claim 1, wherein the base housing comprises: one or more air inlets; and the base housing further comprises one or more air outlets,
wherein the one or more air outlets are disposed on an upper surface of the base housing;
the upper surface of the base housing is configured to place a kettle; and the one or more air outlets are partially covered by the kettle or are not covered by the kettle, and
wherein the base housing is configured such that, when the air supply component is working, an air flow comes in through the one or more air inlets and comes out through the one or more air outlets.

3. The temperature control apparatus of claim 2,
wherein in an aspect of controlling, based on a first temperature detected by the temperature sensing component, the heating component to start or stop working, so that a first controlled temperature detected by the temperature sensing component is maintained in a first temperature interval, the controller is specifically configured to: in response to determining that the first temperature detected by the temperature sensing component is lower than a lowest temperature of the first temperature interval, control the heating component to start working, and in response to determining that the first temperature detected by the temperature sensing component falls in the first temperature interval, control the heating component to stop working; and
wherein in an aspect of the controlling, based on a temperature detected by the temperature sensing component, the air supply component to start or stop working, so that a controlled temperature detected by the temperature sensing component is maintained in a second temperature interval, the controller is specifically configured to: in response to determining that the temperature detected by the temperature sensing component is higher than a highest temperature of the second temperature interval, control the air supply component to start working, and in response to determining that the temperature detected by the temperature sensing component falls in the second temperature interval, control the air supply component to stop working.

4. The temperature control apparatus of claim 3, further comprising an air flow transfer housing disposed above the base housing, wherein the air flow transfer housing and the base housing are configured such that, when the kettle is placed on the upper surface of the base housing, a first air flow passage exists between the air flow transfer housing and an outer wall of the kettle to transfer the air flow out from the one or more air outlets.

5. The temperature control apparatus of claim 4, wherein an inner wall of the air flow transfer housing has a plurality of grooves configured to form the first air flow passage.

6. The temperature control apparatus of claim 4,
wherein in an aspect of controlling, based on a first temperature detected by the temperature sensing component, the heating component to start or stop working, so that a first controlled temperature detected by the temperature sensing component is maintained in a first temperature interval, the controller is specifically configured to: in response to determining that the first temperature detected by the temperature sensing component is lower than the lowest temperature of the first temperature interval, control the heating component and the air supply component to start working, and in response to determining that the first temperature detected by the temperature sensing component falls in the first temperature interval, control the heating component and the air supply component to stop working.

7. The temperature control apparatus of claim 1, wherein the first temperature interval is same as the second temperature interval.

8. The temperature control apparatus of claim 7, further comprising a pH sensing component electrically connected to the controller,
wherein the controller is configured to: stop the temperature control if a pH value detected by the pH sensing component falls in a first pH value interval, and
remind a user if the pH value detected by the pH sensing component falls in a second pH value interval different from the first pH value interval.

9. The temperature control apparatus of claim 8, further comprising a first communications interface, wherein the pH sensing component comprises: a pH sensor, a communications data line, and a second communications interface connected to the pH sensor by the communications data line, and wherein the first communications interface is connected to the second communications interface so that the pH sensing component is electrically connected to the controller, and the pH sensor is configured to detect a pH value of a liquid accommodated by a kettle placed on an upper surface of the base housing.

10. The temperature control apparatus of claim 7, wherein the controller is configured to stop the temperature control if a first constant temperature duration in which the controller performs the temperature control is no less than a preset constant temperature duration, and
wherein the preset constant temperature duration is determined based on one of the following: a constant temperature duration operation performed by a user on the temperature control apparatus, constant temperature duration operation information sent by a target terminal, or a default constant temperature duration of the temperature control apparatus.

11. The temperature control apparatus of claim 10, further comprising a wireless communications module,
wherein the controller is configured to: send at least one of a detected temperature, the detected pH value, the first constant temperature duration, or a remaining constant temperature duration to the target terminal at a preset time interval by using the wireless communications module, wherein the remaining constant temperature duration is a difference obtained by subtracting the first constant temperature duration from the preset constant temperature duration; and
receive temperature interval operation information, pH value interval operation information, or constant temperature duration operation information by using the wireless communications module.

12. The temperature control apparatus of claim 1, wherein a part of an upper surface of the base housing comprises a heat conducting plate, wherein and the heat conducting plate is in contact with the heating component and configured to conduct heat generated by the heating component, and
wherein the temperature sensing component is disposed in the inner cavity of the base housing and touches the heat conducting plate to detect a conducted temperature.

13. The temperature control apparatus of claim 1, further comprising a first communications interface, wherein the temperature sensing component comprises: a temperature sensor, a communications data line, and a third communications interface connected to the temperature sensor by the communications data line, wherein the first communications interface is connected to the third communications interface so that the temperature sensing component is electrically connected to the controller and configured to detect a temperature of the liquid accommodated by a kettle placed on an upper surface of the base housing.

14. The temperature control apparatus of claim 1, further comprising a kettle placed on an upper surface of the base housing, and wherein the kettle comprises: a kettle body made of a glass material, and a kettle cover including an air-permeable covering component, the kettle cover being detachably connected to the kettle body.

15-60. (canceled)
